(19) United States
(12) Patent Application Publication
(10) Pub. No.: US 2008/0266643 A1
(43) Pub. Date: Oct. 30, 2008

(54) Electrode for Reversible Color Change Display Device and Method of Producing the Same, and Reversible Color Change Display Device and Reversible Color Change Lighting Control Device

(75) Inventors: Tohru Kawamoto, Ibaraki (JP); Hisashi Tanaka, Ibaraki (JP); Shigeo Hara, Ibaraki (JP); Madoka Tokumoto, Ibaraki (JP); Masato Kurihara, Yamagata (JP); Masatomi Sakamoto, Yamagata (JP); Mami Yamada, Ishikawa (JP)

Correspondence Address: BIRCH STEWART KOLASCH & BIRCH, PO BOX 747, FALLS CHURCH, VA, 22040-0747, US

(73) Assignees: National Institute of Advanced Industrial Science and Technology, Tokyo (JP); Japan Advanced Institute of Science and Technology, Nomi-Shi (JP)

(21) Appl. No.: 11/990,449

(22) PCT Filed: Aug. 16, 2006
(86) PCT No.: PCT/JP2006/316112

§ 371 Date: Jun. 25, 2008

(30) Foreign Application Priority Data
Aug. 19, 2005 (JP) 2005-239177
Jul. 11, 2006 (JP) 2006-190958

(51) Int. Cl. G02F 1/153; B32B 5/16; B05D 5/12

(52) U.S. Cl. 359/275; 428/403; 427/108

(57) ABSTRACT

An electrode member (10A) for a reversibly color changeable display device, having: a transparent electrically-conductive structural layer (10C); and a reversibly color changeable film layer (3) disposed at one side of the transparent electrically-conductive structural layer (10C), the reversibly color changeable film layer (3) being formed by a dispersion liquid containing ultrafine particles, so that a color of the reversibly color changeable film layer (3) can be changed under control, by applying a voltage to the transparent electrically-conductive structural layer (10C) and an electrically-conductive counter electrode structural layer (10B), with an electrolyte layer (4) provided at one side of the reversibly color changeable film layer (3), and the electrically-conductive counter electrode structural layer (10B) provided at an outside of the electrolyte layer (4).

### TECHNICAL FIELD

The present invention relates to an electrode member for a reversibly color changeable display device and a method of producing the same, and a reversibly color changeable display device and a reversibly color changeable lighting control device (dimmer). Further, the present invention relates to an electrode member for a reversibly color changeable display device including a film layer of ultrafine particles, which is formed by using a dispersion liquid of ultrafine particles of a Prussian blue-type metal complex having color changing properties, a method of producing the same, a reversibly color changeable display device, and a reversibly color changeable lighting control device.

### BACKGROUND ART

If the color of a substance can be changed freely under control through the application of voltage, such a technology can be applied to optical function devices, such as a power-saving display device (e.g., electronic paper) and a light control glass capable of adjusting the transmittance of light. With respect to the electronic paper, a device using a viologen molecule toward the practical use is being developed by Ntera. Such a display can realize a high contrast ratio, and then it is expected as a substitute for a paper print. Moreover, the development of such a technology is desired for a large number of practical intended uses, such as price display boards at supermarkets and the like, a dial face of a clock, and an information display at public places. However, since the viologen to be used in that technique develops only blue color, multi-colorization cannot be achieved.

The light control glass refers to a glass capable of controlling a color (between transparent colorless and colored), and therefore, various applications of the light control glass are conceived. For example, the light control glass is applied to sunglasses which can become transparent at a bright place and can be colored at a dark place. Some of the various applications have been put into practical use. However, also in this field, currently used color materials are limited in the color when colored due to the material properties.

The possibility of realizing multi-colorization using an electrochromic phenomenon has been studied using some materials. Mentioned as one example is a method using organic molecules such as phthalic acid. In this case, although multi-colorization is realized, there are difficulties in using as a display device or a light control device in that controlling of the color is allowed only when voltage is applied.

As another possibility, there is a Prussian blue-type metal complex typified by Prussian blue (Fe₄[Fe(CN)₆]₃). The crystalline structure of the Prussian blue-type metal complex will be described referring to FIG. 23 (Prussian blue-type metal complex crystal 220 refers to a substance which has the crystal structure of Prussian blue as a base in which a transition metal and a cyano group may be substituted or have defects and various ions and water may be placed into vacancies) The structure will be described below in detail. The crystal structure of the Prussian blue-type metal complex refers to a structure in which two kinds of metal atoms M₁ and M₂ that have an NaCl type lattice (M₁ and M₂ represent a metal atom 221 and a metal atom 224, respectively, in FIG. 23) are three-dimensionally crosslinked by a cyano group including a carbon atom 222 and a nitrogen atom 223. As one phenomenon thereof, an electrochromic phenomenon is mentioned. However, in producing a high-performance color-changing device in practical use by using such metal complexes, there were problems in production of a high-quality film and obtaining a fine structure. In order to solve the problems, there are reports, which will be described later, of attempts to improve the Prussian blue-type metal complex. However, the reports refer to the problems described below, and therefore, such technologies have not yet put into practical use.

Non-patent Document 1 discloses an extracted and mixed liquid of a Prussian blue prepared by using a surfactant (hexadecyl trimethyl ammonium chloride (HTAC)). Thus, the realizations of film formation and obtaining a fine structure utilizing a printing technology are expected. However, a large amount of expensive surfactants are required, so such a technology is not suitable for industrial-scale production. In addition, a protective molecule having coordination ability is not disclosed, and, generally, a Prussian blue cannot be separated from such a mixed solution to obtain as a fine-particle powder material, and cannot be re-dispersed in another solvent. Moreover, even if the mixed liquid is tried to be used as an electrochromic material, when the mixed liquid is made adjacent to an electrolyte layer including an organic solvent, the mixed liquid elutes and disperses in the electrolyte layer. Therefore, usable materials are limited.

For a similar object, there is an example in which the production of an electrochromic device has been attempted by dispersing particles of a Prussian blue-type complex in a solvent. For example, in Patent Document 1, electrochromic properties are confirmed by using a Prussian blue dispersion liquid as an electrode layer containing a water-soluble polymer compound as a binder. However, this is a dispersion liquid of a particular binder (specific water-soluble polymer compounds such as polyvinyl alcohol). Prussian blue crystal fine-particles are integrated with a particular essential binder, and organic solvents (toluene and the like) required in a general industrial production cannot be used, resultant in that the applications thereof are limited. Further, the degree of polymerization of the above-mentioned binder polymer compound is 100 or more, whereby it is difficult to remove the polymer, and there is a high possibility that there arise problems in the electrochromic performances, especially in a reaction rate and the like.

Non-patent Document 2 discloses a production method in which layers of nano-sized particles of an exposed Prussian blue-type complex having no protecting ligand are formed one by one according to a Layer by Layer method. However, the production method needs four steps and takes 30 minutes for forming one layer, so it is impracticable to perform industrial-scale production. Moreover, also in this method, the solvent is limited to water, and thus the applications thereof are limited. In particular, such a production method cannot employ a film-forming method by coating, using a common organic solvent (toluene and the like) including a printing technology. Therefore, it is difficult to apply such a production method to industrial application and micro processing.

Recently, a method has been studied which obtains, as fine-particles, a Prussian blue-type metal complex covered with a low molecular weight compound (see Non-patent Documents 3 to 6). In the documents, synthesizing methods of fine particles are schematically described and the particle sizes, the magnetic properties, etc. of the fine particles are disclosed. However, there is no description on the production of an electrochromic element using the same.

Patent Document 1: JP-A-01-219723 (“JP-A” means unexamined published Japanese patent application)

### Non-patent Document 1: N. Toshima et al, Chemistry Letters, 1990, p. 485

Non-patent Document 2: D. M. Delongchamp et al, Chem. Matter., 2004, 16, p. 4799
Non-patent Document 3: Mami Yamada et al, J. Am. Chem. Soc., 126 (2004) pp. 9482-9483
Non-patent Document 4: Kurihara Masato, “Search for boundary between complex chemistry and practical use of it”, organized by The Chemical Society of Japan, Tohoku branch, (22th, Inorganic/Analytical Chemistry Colloquium), Jul. 1 and 2, 2005, Synopses
Non-patent Document 5: Mami Yamada, “Synthesis and physical property behavior of Prussian blue-type Fe/Cr—CN—Co complex nano-sized fine-particles by reverse micelle method” organized by the planning group of the Grant-in-Aid for Scientific Research, supported by the Chemical Society of Japan (3rd “Molecular Spin” symposium), Jan. 8 and 9, 2005, Synopses, pp. 32 and 33

### Non-patent Document 6: N. Bagkar et al, Journal of Materials Chemistry, 2004, 14, p.1430

### DISCLOSURE OF THE INVENTION

The present invention contemplates for providing an electrode member for a reversibly color changeable display device which can achieve multi-colorization, a method of producing the same, a reversibly color changeable display device, and a reversibly color changeable lighting control device. More specifically, the present invention contemplates for providing, by using not fine particles but ultrafine particles, a high-performance electrode member for a reversibly color changeable display device which can electrically control the color of a film layer and can reversibly change the color, a method of producing the same, a reversibly color changeable display device, and a reversibly color changeable lighting control device. Moreover, the present invention contemplates for providing a high-performance electrode member for a reversibly color changeable display device which allows the formation of a precision film and ultrafine processing and can achieve a uniform image without requiring a great deal of time periods and processing steps, a method of producing the same, a reversibly color changeable display device, and a reversibly color changeable lighting control device.

According to the present invention, there is provided the following means:

(1) An electrode member for a reversibly color changeable display device, comprising:

a transparent electrically-conductive structural layer; and

a reversibly color changeable film layer disposed at one side of the transparent electrically-conductive structural layer, the reversibly color changeable film layer being formed by a dispersion liquid containing ultrafine particles,

so that a color of the reversibly color changeable film layer can be changed under control, by applying a voltage to the transparent electrically-conductive structural layer and an electrically-conductive counter electrode structural layer, with an electrolyte layer provided at one side of the reversibly color changeable film layer, and the electrically-conductive counter electrode structural layer provided at an outside of the electrolyte layer.

(2) The electrode member for a reversibly color changeable display device according to (1), wherein the ultrafine particles are Prussian blue-type metal complex-ultrafine particles.

(3) The electrode member for a reversibly color changeable display device according to (1) or (2), wherein the ultrafine particles are ultrafine particles which have an average particle diameter of 200 nm or less and in which one or two or more compound containing a pyridyl group or an amino group is coordinated as a protecting ligand to a Prussian blue-type metal complex crystal having a metal atom M₁ and a metal atom M₂ set forth in the below. [the metal atom M₁: at least one metal atom selected from the group consisting of vanadium, chromium, molybdenum, tungsten, manganese, iron, ruthenium, cobalt, nickel, platinum, rhodium, osmium, iridium, palladium, and copper.] [the metal atom M₂: at least one metal atom selected from the group consisting of vanadium, chromium, manganese, iron, ruthenium, cobalt, rhodium, nickel, palladium, platinum, copper silver, zinc, lanthanum, europium, gadolinium, lutetium, barium, strontium, and calcium.]

(4) The electrode member for a reversibly color changeable display device according to (3), wherein the protecting ligand has carbon atoms of 4 or more and 100 or less.

(5) The electrode member for a reversibly color changeable display device according to (3) or (4), wherein the protecting ligand is represented by any one of formulae (1) to (3):

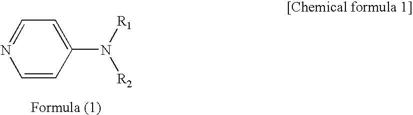

wherein R₁ and R₂ each independently represent a hydrogen atom, or an alkyl group, alkenyl group or alkynyl group having 8 or more carbon atoms;

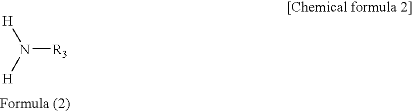

wherein R₃ represents an alkyl group, alkenyl group or alkynyl group having 8 or more carbon atoms;

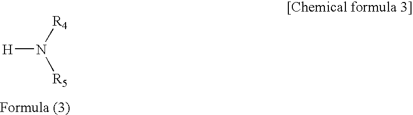

wherein R₄ represents an alkyl group, alkenyl group or alkynyl group having 6 or more carbon atoms; and R₅ represents an alkyl group, an alkenyl group, or an alkynyl group.

(6) The electrode member for a reversibly color changeable display device according to (5), wherein the substituents R₁ to R₄ each represent an alkenyl group.

(7) The electrode member for a reversibly color changeable display device according to any one of (3) to (6), wherein a content of the protecting ligand compound in the reversibly color changeable film layer is 10 times or less a content of the Prussian blue-type metal complex in terms of mass ratio.

(8) The electrode member for a reversibly color changeable display device according to any one of (1) to (7), wherein the reversibly color changeable film layer is a liquid film layer having a uniform thickness which is formed by a dispersion liquid containing the Prussian blue-type metal complex-ultrafine particles by a film formation method selected from a spin coating method, a spraying method, an ink jet method, and a printing method.

(9) The electrode member for a reversibly color changeable display device according to any one of (1) to (8), wherein the dispersion liquid is a dispersion liquid of the Prussian blue-type metal complex-ultrafine particles, which is prepared by a stirring-extraction method.

(10) The electrode member for a reversibly color changeable display device according to any one of (3) to (9), wherein the protecting ligand is removed by heating and/or washing at the time of and/or after the reversibly color changeable film layer is formed.

(11) The electrode member for a reversibly color changeable display device according to any one of (1) to (10), wherein the reversibly color changeable film layer contains an agent for controlling electrochemical properties and/or an agent for controlling color-development properties.

(12) The electrode member for a reversibly color changeable display device according to any one of (1) to (10), wherein the reversibly color changeable film layer has a plurality of film-layers, which at least comprise a layer containing the ultrafine particles and a layer containing an agent for controlling electrochemical properties and/or an agent for controlling color-development properties.

(13) A reversibly color changeable display device, comprising:

an electrolyte layer provided at one side of the reversibly color changeable film layer of the electrode member for a reversibly color changeable display device according to any one of (1) to (12); and

an electrically-conductive counter electrode structural layer provided at an outside thereof.

(14) The reversibly color changeable display device according to (13), wherein:

the electrode member for a reversibly color changeable display device is an electrode member having a transparent insulating layer, in which a transparent electrically-conductive film is provided at one side of the transparent insulating layer, and the reversibly color changeable film layer is provided at another side of the transparent insulating layer;

the electrically-conductive counter electrode structural layer is a structural layer having a counter electrode insulating layer, in which an electrically-conductive counter electrode film is provided at one side of the counter electrode insulating layer; and

an electrolyte layer is placed between the reversibly color changeable film layer and the counter electrode film.

(15) The reversibly color changeable display device according to (13) or (14), wherein the transparent electrically-conductive structural layer and the electrically-conductive counter electrode structural layer are in a form of sheet.

(16) The reversibly color changeable display device according to any one of (13) to (15), wherein a counter electrode modifying layer is provided between the electrolyte layer and the electrically-conductive counter electrode structural layer.

(17) The reversibly color changeable display device according to any one of (13) to (16), wherein a periphery of the electrolyte layer is sealed with a sealing material.

(18) A reversibly color changeable display device, wherein the reversibly color changeable film layer of the electrode member according to any one of (1) to (12) is formed into a (drawing) pattern and/or a character (or letter) pattern with a dispersion liquid in which ultrafine particles are dispersed, an electrolyte layer is provided at one side of the film layer, and an electrically-conductive counter electrode structural layer is provided at an outside thereof,

so that the pattern and/or the character is displayed under electrical control.

(19) A reversibly color changeable lighting control device, comprising:

an electrolyte layer which is provided at one side of the reversibly color changeable film layer of the electrode member according to any one of (1) to (12); and

a transparent electrically-conductive counter electrode structural layer which is provided at an outside thereof,

so that a transmitted light is electrically controlled for controlling light.

(20) A method of producing the electrode member according to any one of (1) to (12) for a reversibly color changeable display device, comprising the steps of;

preparing a dispersion liquid in which ultrafine particles of a Prussian blue-type metal complex having a protecting ligand are dispersed by a stirring-extraction method or a reversed micelle method; and

applying the dispersion liquid to one side of a transparent electrically-conductive structural layer, to form a reversibly color changeable film layer.

(21) The method of producing an electrode member for a reversibly color changeable display device according to (20), wherein;

the protecting ligand is a compound containing an amino group or a pyridyl group; and

the dispersion liquid is applied to form the film by a film formation method selected from a spin coating method, a spraying method, an ink jet method, and a printing method.

(22) The method of producing an electrode member for a reversibly color changeable display device according to (20) or (21), further comprising;

removing the protecting ligand by washing and/or heating at the time of and/or after the formation of the reversibly color changeable film layer.

(23) The method of producing an electrode member for a reversibly color changeable display device according to any one of (20) to (22), wherein:

the metal atom M₁ and/or the metal atom M₂ of the Prussian blue-type metal complex each are a combination of two or more metals; and

the metal compositions are changed, to control optical properties of the complex, thereby to obtain ultrafine particles capable of developing a desired color under electrical controlling.

Other and further features and advantages of the invention will appear more fully from the following description, appropriately referring to the accompanying drawings.

### BRIEF DESCRIPTION OF THE DRAWINGS

FIG. 1 is a cross sectional view schematically illustrating an example of a preferable aspect of an electrode member for a reversibly color changeable display device of the present invention and a reversibly color changeable display device of the present invention using the same.

FIG. 2 is an explanatory view schematically illustrating the structure of Prussian blue-type metal complex-ultrafine particles for use in the electrode member for a reversibly color changeable display device of the present invention.

FIG. 3 are views illustrating measurement results of powder X-ray diffraction for Prussian blue crystals and ultrafine particles thereof; FIG. 3(I) shows peak positions of a standard sample; and FIG. 3(II) shows measurement results of the obtained sample.

FIG. 4 is a graph showing results of FT-IR measurement of Prussian blue crystals and the ultrafine particles thereof.

FIG. 5 is a UV-visible absorption spectrum of Prussian blue ultrafine-particulate dispersion liquid.

FIG. 6 shows a photograph, substituting for a drawing, of a transmission electron microscope (TEM) image of organic solvent-dispersible Prussian blue ultrafine-particles.

FIG. 7 shows a photograph, substituting for a drawing, of a TEM image of water-dispersible Prussian blue ultrafine-particles.

FIG. 8 is a UV-visible spectrum of cobalt-iron-cyano complex ultrafine-particles (solvent: toluene).

FIG. 9 is an absorption spectrum of Prussian blue-type metal complex-ultrafine particles obtained by changing the composition (iron-nickel composition) of a metal atom M₂.

FIG. 10 is a photograph, substituting for a drawing of a TEM image of cobalt-iron-cyano complex ultrafine-particles.

FIG. 11 is a graph illustrating measurement results of particle size distribution of a dispersion liquid of Prussian blue-type metal complex-ultrafine particles.

FIG. 12 is a graph illustrating measurement results of the film thickness of a film layer of ultrafine particles of the electrode member for a reversibly color changeable display device according to a preferable aspect of the present invention.

FIG. 13 illustrates measurement results of a cyclic voltammetry of the electrode member for a reversibly color changeable display device according to a preferable aspect of the present invention.

FIG. 14 is a graph illustrating changes in absorption spectra when applying a voltage to an electrode member for a reversibly color changeable display device according to another preferable aspect of the present invention.

FIG. 15 is a graph illustrating changes in absorption spectra when applying a voltage to an electrode member for a reversibly color changeable display device according to further another preferable aspect of the present invention.

FIG. 16 is a photograph, substituting for a drawing, illustrating an electrode member for a reversibly color changeable display device of the present invention which has a heart-shaped film of Prussian blue-type metal complex-ultrafine particles.

FIG. 17-1(a-1) is a plan view schematically illustrating an example of the structure of the electrode member for a reversibly color changeable display device of the present invention; and FIG. 17-1(a-2) is a cross sectional view along the A-A line.

FIG. 17-2(b-1) is a plan view schematically illustrating an example of the structure of a sealing material; and FIG. 17-2(b-2) is a cross sectional view along the B-B line.

FIG. 17-3(c-1) is a plan view schematically illustrating an example of the structure of an electrically-conductive counter electrode structural layer; and FIG. 17-3(c-2) is a cross sectional view along the C-C line.

FIG. 17-4(d-1) is a plan view schematically illustrating an example of the structure of a reversibly color changeable display device of the present invention; and FIG. 17-4(d-2) is a cross sectional view along the D-D line.

FIG. 18 is a graph illustrating changes in absorption spectra when applying a different voltage to a reversibly color changeable display device of the present invention according to a preferable aspect of the present invention.

FIG. 19 is a graph illustrating an effect of reducing response time when coating a film layer of ultrafine particles with ferrocene in a reversibly color changeable display device according to a preferable aspect of the present invention.

FIG. 20 is a graph illustrating changes with the lapse of time in the transmittance upon the application of voltage to a reversibly color changeable display device according to another preferable aspect of the present invention.

FIG. 21 is a graph illustrating changes in infrared spectroscopy spectra when performing each treatment to a sample in which a dispersion liquid of FeHCF-OA fine particles was added dropwise to a KBr pellet.

FIG. 22 illustrates cyclic voltammetry measurement results showing the improvement in the responsiveness when the electrode member for a reversibly color changeable display device of the present invention was heated.

FIG. 23 is an explanatory view schematically illustrating the crystalline structure of Prussian blue-type metal complex

In the figures, the main numerical references are as follows.

10 Reversibly color changeable display device

10A Electrode member for a reversibly color changeable display device

10B Electrically-conductive counter electrode structural layer

10C Transparent electrically-conductive structural layer

1 Transparent insulating layer

2 Transparent electrically-conductive film

3 Reversibly color changeable film layer

4 Electrolyte layer

6 Electrically-conductive counter electrode film

7 Counter electrode-side insulating layer

21 Prussian blue-type metal complex (microcrystal)

22 Ligand L

31 Results of X-ray diffraction measurement of Prussian blue crystal

32 Results of X-ray diffraction measurement of water-dispersible Prussian blue ultrafine-particles

33 Results of X-ray diffraction measurement of organic solvent-dispersible Prussian blue ultrafine-particies

41 Infrared absorption spectrum of Prussian blue crystals

42 Infrared absorption spectrum of water-dispersible Prussian blue ultrafine-particles

43 Infrared absorption spectrum of organic solvent-dispersible Prussian blue ultrafine-particles

51 UV-visible absorption spectrum of Prussian blue ultrafine-particles (a dispersion liquid in toluene)

52 UV-visible absorption spectrum of Prussian blue ultrafine-particles (a dispersion liquid in water)

121 Absorption spectrum when a voltage of 1.5V was applied to an electrode member for a reversibly color changeable display device

122 Absorption spectrum before and upon application of a voltage of −1.0V to an electrode member for a reversibly color changeable display device

150A Electrode member for a reversibly color changeable display device

150B Electrically-conductive counter electrode structural layer

150C Reversibly color changeable display device

150D Transparent electrically-conductive structural layer

151 Transparent insulating layer

152 Transparent electrically-conductive film

153 Reversibly color changeable film layer

154 Sealing material

155 Electrically-conductive counter electrode film

156 Counter electrode-side insulating layer

157 Electrolyte

220 Prussian blue-type metal complex

221 Metal atom M₁

222 Carbon atom

223 Nitrogen atom

224 Metal atom M₂

### BEST MODE FOR CARRYING OUT THE INVENTION

Hereinafter, the present invention will be described in detail.

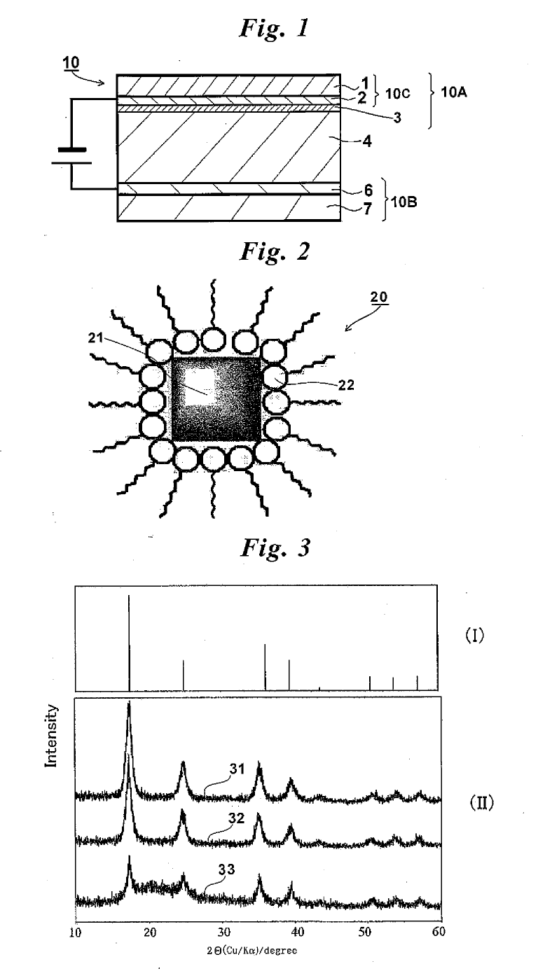

FIG. 1 illustrates an example, according to a preferable aspect of the present invention, of the electrode member for a reversibly color changeable display device and a reversibly color changeable display device using the same. As illustrated in FIG. 1, an electrode member for a reversibly color changeable display device 10A of the present invention includes a reversibly color changeable film layer 3, which is formed with a dispersion liquid containing ultrafine particles at one side of a transparent conductive structural layer 10C. An electrolyte layer 4 is provided at an open surface side of the reversibly color changeable film layer 3, and an electrically-conductive counter electrode structural layer 10B is provided at the outside thereof. A voltage is applied to the transparent electrically-conductive structural layer 10C and the electrically-conductive counter electrode structural layer 10B, thereby to enable to reversibly change the color of the reversibly color changeable film layer 3 under control. In the present invention, it should be noted that the electrically-conductive structural layer not only refers to a substance in which an electrically-conductive film is provided at one side of an insulating layer such as a substrate, but also refers to an electric conductor which contains an electrically-conductive material and does not contain an insulating layer or refers to a substance containing only an electrically-conductive layer.

In the electrode member for a reversibly color changeable display device of the present invention, it is preferable that the transparent electrically-conductive structural layer 10C includes a transparent insulating layer 1 and a transparent electrically-conductive film 2. It is preferable that the electrically-conductive counter electrode structural layer 10B includes a counter electrode insulating layer 7 and an electrically-conductive counter electrode film 6.

There is no particular limitation on the material of the transparent insulating layer 1 insofar as it is transparent and insulative, and for example, glass, quartz, and a transparent insulating polymer (polyethylene terephthalate, polycarbonate) can be used.

There is no particular limitation on the material of the transparent electrically-conductive film 2 insofar as it is transparent and electrically conductive, and indium tin oxide (ITO), tin oxide, zinc oxide, tin-oxide cadmium, other substances which are transparent and shows metallically conductivity, etc., can be used.

The reversibly color changeable film layer 3 refers to a film layer formed by using a dispersion liquid containing nano-sized fine-particles (nanometer-order particles). The nano-sized fine-particles and the film layer will be described later in detail.

It is preferable that the electrolyte layer 4 is composed of a solid or liquid electrolyte, and use can be preferably made, for example, of water (electrolytic water) or the like as a specific material. The electrolyte layer 4 may contain an agent for controlling electrochemical properties, an agent for controlling color-development properties, etc., which are mentioned later.

For the electrically-conductive counter electrode film 6, gold, silver, copper, aluminum, ITO, tin oxide, zinc oxide, electrically-conductive polymers, etc., can be used.

There is no limitation on a material for the counter electrode-side insulating layer 7 insofar as it is a solid material which is not electrically conductive. Use can be made, for example, of glass, quartz; an insulating polymer, which is typified by polyethylene terephthalate; ceramics; an oxide; and a rubber.

Further, a counter electrode modifying layer may be provided, as required, between the electrolyte layer and the electrically-conductive structural layer (or the electrically-conductive counter electrode film). The counter electrode modifying layer is preferably a layer including the agent for controlling electrochemical properties and/or the agent for controlling color-development properties (ferrocene or the like). The counter electrode modifying layer can be provided as a layer including various materials so as to improve device properties. Moreover, as a substance that can be contained in the counter electrode modifying layer, use may be made of materials having electrochromic properties, such as ultrafine particles of a Prussian blue-type metal complex, which are mentioned later.

Moreover, a sealing material can be provided as required, and it is preferable to use an insulating material which can prevent the outflow of electrolyte. For example, various kinds of insulating plastics, glasses, ceramics, oxides, and rubbers can be used.

The electrode member for a reversibly color changeable display device of the present invention and the reversibly color changeable display device using the same are not particularly limited in the shape, and can be formed into suitable shapes according to the intended uses. Each layer does not need to have the same shape. The dimension of each layer is not limited, and when produced as a device for a large screen display, the dimension can be adjusted, for example, to 1 to 3 m² in terms of area. Alternatively when produced as ultrafine pixels for colored display, the dimension is preferably set to 1.0×10⁻¹⁰ to 1.0×10⁻¹ m², and more preferably about 1.0×10⁻⁸ m², for example. As described later, the reversibly color changeable film layer can be formed into an applied layer having a uniform thickness which is formed by applying a dispersion liquid, which allows uniform and clear displaying even in the case of large screen pixels and ultrafine pixels.

For example, when displaying patterns, character patterns, etc., of desired shapes, a color displaying region may be designed by forming the reversibly color changeable film layer into a desired shape or a color displaying region may be designed by widespreadly forming the reversibly color changeable film layer itself and forming an electrically-conductive structural layer (or electrically-conductive film) under the reversibly color changeable film layer into a desired shape. It should be noted-that the reversibly color changeable display device of the present invention can reversibly change and display the color of patterns or character patterns, as well as it can change the coloration of an entire device, thereby to change the color of the wall surface of the inside of a room of a residence or a store freely, or to adjust and control a color pattern of the wall surface.

A reversibly color changeable lighting control device can be obtained by using a transparent material as the electrically-conductive counter electrode structural layer (an electrically-conductive counter electrode film, a counter electrode-side insulating layer, etc.), specifically, the above-mentioned materials of the transparent electrically-conductive film and transparent insulating layer can be used.

As another more specific application example, when producing a segment-type display, such as a price display at supermarkets, a plurality of the reversibly color changeable display devices of FIG. 1 can be combined, for example. When forming a device containing a plurality of pixels for use in an electronic paper and the like, it is preferable to form a substance in which the devices including the reversibly color changeable display devices are arranged in a lattice. In that case, usual control methods can be used as a display control method, such as a passive-matrix method and an active-matrix method. Moreover, when various patterns are formed by using a printing technology and are provided to the surface of artifacts such as furniture, buildings, and car bodies, the appearance of the artifacts on which the patterns are provided can be changed by controlling display/non-display of the patterns.

The electrode member for a reversibly color changeable display device of the present invention has a film layer of ultrafine particles formed of a dispersion liquid containing nano-sized fine-particles, as a reversibly color changeable film layer. Examples of the nano-sized fine-particles include Prussian blue-type metal complex-ultrafine particles which exhibit electrochromic properties.

The color can be controlled and changed electrochemically, by designing molecules of the Prussian blue-type metal complex to obtain a desired complex composition, or by utilizing an oxidation-reduction reaction or the like of the Prussian blue-type metal complex. For example, Prussian blue Fe₄[Fe(CN)₆]₃, which exhibits a dark blue color, becomes colorless by reduction. Moreover, Ni₃[Fe(CN)₆]₂ and In[Fe(CN)₆] exhibit a yellow color and Co[Fe(CN)₆] exhibits a red color. Thus, as the Prussian blue-type metal complex, a substance can be synthesized, which exhibits various colors by suitably designing the complex structure. In the electrode member for a reversibly color changeable display device of the present invention, it is preferable to employ such ultrafine particles having color controllability and to make the particles colorless by oxidization or reduction thereof. According to the electrode member of the present invention, multi-colorization can be achieved, by controlling the colors of the fine particles, for example, by designing a complex as described above. Moreover, the color density can be successively changed depending on the reduction (oxidation) amount, thereby to achieve multi gradation. The color development can be controlled, by mixing a plurality kinds of fine particles which develop several different colors, or by mixing a plurality kinds of metals in a single kind of fine particles at a transition metal position.

Moreover, the reversibly color changeable display device of the present invention can be utilized to function as a color recording type display device in which the color is changed by applying a voltage, and the displayed color after changing is recorded and maintained even after the application of the voltage is stopped. The displayed color recording period of time varies depending on ultrafine particle materials to be used and a voltage applying time. For example, it is preferable to confirm visually that the same color pattern is maintained for about 1 second or more, after stopping the application of the voltage and opening the circuit of the apparatus.

The Prussian blue-type metal complex-ultrafine particles which can be used for the electrode member for a reversibly color changeable display device of the present invention, can be schematically described with reference to FIG. 2. More specifically, in an individual ultrafine particle 20, a ligand L (22) is coordinated to the surface of a Prussian blue-type metal complex microcrystal 21. However, FIG. 2 does not illustrate the relationship in the size between the crystal and the ligand of the ultrafine particle. The respective ligand may stand straight on the surface of the crystal as illustrated in FIG. 2, drop toward the surface, or be in another state.

The coordination amount of the ligand L when preparing ultrafine particles is not limited, and varies depending on the particle diameters and particle shapes of ultrafine particles. For example, it is preferable that the coordination amount be about 5 to 30% in a molar ratio, with respect to the metal atom (the total amount of metal atoms M₁ and M₂) in the crystal of the Prussian blue-type metal complex (the amount of ligand in the film layer of ultrafine particles will be mentioned later). Thus, a stable dispersion liquid containing the nano-sized fine-particles of the Prussian blue-type metal complex can be obtained, and a high-quality film layer of ultrafine particles can be produced by liquid process for film fabrication.

The Prussian blue-type metal complex 21 may have a defect/a vacancy in the crystalline lattice, as described above. For example, the vacancy may be placed at the position of an iron atom, and a cyano group around the vacancy may be substituted by water. It is also preferable to adjust the amount and arrangement of such vacancies in order to control the optical properties.

In the present invention, the “ultrafine particles” refer to particles which are in the form of nano-sized fine-particles (particles ultrafine-wise made into nanometer-order) when forming a film and which can be dispersed, isolated, and re-dispersed in various solvents in the state of nano-sized particles. Particles which cannot be isolated from a dispersion liquid or from a dispersion liquid composite and which cannot be isolated and re-dispersed into a dispersion liquid are not included, The average particle diameter is preferably 200 nm or less, and more preferably 50 nm or less.

In the present invention, unless otherwise specified, the particle diameter refers to a diameter of a primary particle containing no protecting ligand and refers to a circle equivalent diameter (a value calculated as a diameter of a circle whose area is equal to the projected area of an individual particle, from an image of ultrafine particles obtained through electron microscope observation). Unless otherwise specified, the average particle diameter refers to an average value of values obtained by measuring the particle diameter of at least 30 ultrafine particles as described above. Alternatively, the average particle diameter may be estimated from the average diameter calculated from the half-height width of the signal by powder X-ray diffraction (XRD) measurement of a powder of the ultrafine particles.

It should be noted that a plurality of nano-sized particles may move as a secondary particle in a group when the ultrafine particles are dispersed in a solvent. In this case, a larger average particle diameter may be observed depending on a method of the measurement. When the ultrafine particles form secondary particles in a dispersed state, the average particle diameter thereof is preferably 200 nm or less. It should be noted that still larger aggregated particles may be formed due to the elimination of the protecting ligand by, for example, treatment after the film formation as an ultrafine particle film. Those do not limit the scope of the invention.

For example, as the method of preparing the dispersion liquid including the Prussian blue-type metal complex-ultrafine particles include a stirring-extraction method, a reversed micelle method, and a method using ferritin or the like as a template can be used. Hereinafter, the stirring-extraction method and the reversed micelle method, which are preferably employed in the present invention, will be described in detail. However, the methods do not limit the present invention.

### <Stirring-Extraction Method>

The stirring-extraction method is preferable because a large amount of fine particles with various protecting ligands coordinating to the particle surface can be produced without a special compound used in the reversed micelle method mentioned later. The typical procedure thereof is as follows: a solution of a metal cyano-coordinating complex (anion) including the metal atom M₁ as a central metal, and a metal cation solution including the metal atom M₂ as a central metal are mixed; the crystals of the Prussian blue-type metal complex including the metal atoms M₁ and M₂ are precipitated; the resultant Prussian blue-type complex crystals are added to the solvent dissolved with the protecting ligand L, followed by stirring; and then the solvent is removed, thereby to obtain a solid-powder ultrafine particle assembly (aggregation) with a particle diameter of 50 nm or less, for example.

The stirring-extraction method is explained in more detail, the dispersion liquid of the Prussian blue-type metal complex ultrafine particles is prepared by the steps including the following (A) and (B). The ultrafine particles are obtained by the steps including the following (A), (B), and (C). Further, as a preferable embodiment, in the case of preparation of an organic solvent-dispersible ultrafine-particles, the step (B) is changed to the step (B1); and in the case of preparation of a water-dispersible ultrafine-particles, the step (B) is changed to the step (B2). Hereinafter, the respective step will be explained in detail.

The step (A) is a mixing of an aqueous solution including a metal-cyano complex (anion) whose central metal is a metal atom M₁, and an aqueous solution containing metal cation of a metal atom M₂, thereby to precipitate crystals of a Prussian blue-type metal complex having the metal atoms M₁ and M₂.

Examples of the metal atom M₁ include vanadium (V), chromium (Cr), molybdenum (Mo), tungsten (W), manganese (Mn), iron (Fe), ruthenium (Ru), cobalt (Co), nickel (Ni), platinum (Pt), copper (Cu), rhodium (Rh), osmium (Os), Iridium (Ir), and palladium (Pd); and the metal atom M₁ is preferably at least any one of those.

Examples of the metal atom M₂ include vanadium (V), chromium (Cr), manganese (Mn), iron (Fe), ruthenium (Ru), cobalt (Co), rhodium (Rh), nickel (Ni), palladium (Pd), platinum (Pt), copper (Cu), silver (Ag), zinc (Zn), lanthanum (La), europium (Eu), gadolinium (Gd), lutetium (Lu), barium (Ba), strontium (Sr), and calcium (Ca); and the metal atom M₂ is preferably at least any one of those.

Among those, as the metal atom M₁, iron, chromium, or cobalt is more preferable, and iron is particularly preferable. As the metal atom M₂, iron, cobalt, nickel, vanadium, copper, manganese, or zinc is more preferable, and iron, cobalt, or nickel is further preferable.

The counter ion of the anionic metal-cyano complex with the atom M₁ as the central atom in the aqueous solution is not limited, and examples thereof include potassium ion, ammonium ion, and sodium ion. The counter ion of the metal cation of the atom M₂ is not limited, and examples thereof include Cl⁻, NO₃⁻, and SO₄²⁻.

The metal atom M₁ or the metal atom M₂ may be a combination of two or more kinds of metals, respectively. In the case of the combination of two kinds of metals for M₁, the combination of iron and chromium, the combination of iron and cobalt, and the combination of chromium and cobalt are preferable, and the combination of iron and chromium is further preferable. For M₂, the combination of iron and nickel, the combination of iron and cobalt, and the combination of nickel and cobalt are preferable, and the combination of iron and nickel is further preferable. In those combinations, it is preferable to control the physical properties of Prussian blue-type metal complex ultrafine particles to be obtained, by adjusting the composition of the metals to be combined, and it is more preferable to control the optical properties thereof.

In those cases, the mixing ratio of the metal-cyano complex and the metal cation is not limited, but it is preferred to mix those so that the ratio “M₁:M₂” would be 1:1 to 1:1.5, in terms of molar ratio.

The step (B) is a step for mixing the solution in which the protecting ligand L is dissolved and the crystals of the Prussian blue-type metal complex obtained in the step (A).

As the protecting ligand, one or two or more compounds having a pyridyl group or an amino group as a binding site with the complex crystal can be preferably used. Among such compounds, it is more preferable to use a compound having 4 or more and 100 or less carbon atoms (in terms of mass average molecular weight, 2,000 or less is preferable, and 50 or more and 1,000 or less is more preferable). It is particularly preferable to use one or two or more compound(s) represented by any one of the following formulae (1) to (3).

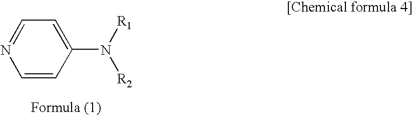

In formula (1), R₁ and R₂ each independently represents a hydrogen atom, or an alkyl group, alkenyl group or alkynyl group, each having 8 or more carbon atoms (preferably having 12 to 18 carbon atoms). R₁ and R₂ are preferably an alkenyl group, in which there is no upper limit on the number of carbon-carbon double bonds therein, it is preferable that the number is 2 or less. When the ligand L having an alkenyl group is used, the dispersibility can be improved even when the compound is hard to disperse in a solvent other than a polar solvent (excluding methanol and acetone from which a ligand may be eliminated, e.g., chloroform). Specifically, using a ligand having an alkenyl group, the resultant compound can favorably disperse in a nonpolar solvent (e.g., hexane), unless the ligand is eliminated. This is the same as in the cases of R₃ and R₄.

Among the compounds represented by formula (1), 4-di-octadecylaminopyridine, 4-octadecylaminopyridine, and the like are preferable.

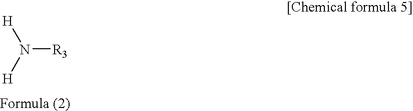

In formula (2), R₃ represents an alkyl group, alkenyl group or alkynyl group, each having 8 or more carbon atoms (preferably having 12 to 18 carbon atoms). R₃ is preferably an alkenyl group. Although there is no upper limit on the number of carbon-carbon double bonds, it is preferable that the number is 2 or less. Among the compounds represented by formula (2), oleylamine is preferable as a ligand having an alkenyl group, and stearylamine is preferable as a ligand having an alkyl group.

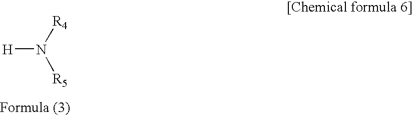

In formula (3), R₄ represents an alkyl group, alkenyl group or alkynyl group, each having 6 or more carbon atoms (preferably having 12 to 18 carbon atoms), and R₅ represents an alkyl group, an alkenyl group, or an alkynyl group (each preferably having 1 to 60 carbon atoms). It is preferable that R₄ be an alkenyl group. There is no upper limit on the number of carbon-carbon double bonds, and it is preferable that the number be 2 or lower.

Meanwhile, the compounds represented by formula (1), (2), or (3) may have a substituent, unless the effects of this invention are obstructed.

It is preferable to select the kind of solvent, in which the protecting ligand L is to be dissolved, taking the combination with the ligand L or the like into consideration. It is more preferable to select a solvent which can sufficiently dissolve the ligand L. In the case that an organic solvent is used as the solvent, toluene, dichloromethane, chloroform, hexane, ether, butyl acetate, and the like are preferable. When a ligand which can dissolve into water, such as 2-amino-ethanol, is used for the ligand L, water can be used as the solvent, and it is also possible to obtain water-dispersible Prussian blue-type metal complex ultrafine-particles. In that case, it is also preferred to use an alcohol as the solvent.

The amount of the solvent is not limited, and it is preferable to set the ratio “(the ligand L):(the solvent)” to 1:5 to 1:50, in terms of mass ratio, for example. The mixing is preferably conducted under stirring, and thus it is possible to obtain a dispersion liquid in which a Prussian blue-type metal complex-ultrafine particles sufficiently disperse in an organic solvent.

With respect to the amount of the ligand L to be added, to the metal ions (the total amount of the metal atoms M₁ and M₂) to be contained in the microcrystal of the Prussian bluetype metal complex as prepared in the step (A), it is preferable that the ratio {(M₁+M₂):L} is about 1:0.2 to about 1:2, in terms of molar ratio.

In preparation of organic solvent-dispersible ultrafine particles, the step (B1) is a step for mixing the organic solution in which the ligand L is dissolved into an organic solvent, with the crystals of the Prussian blue-type metal complex as obtained in the step (A). From the viewpoint of accelerating the production speed of the ultrafine particles of the Prussian blue-type metal complex, an addition of water in this step is preferable, and the amount of the water to be added is preferably such an amount that the ratio “the solvent:the water” would be 1:0.01 to 1.0.1, in terms of mass ratio.

In preparation of water-dispersible ultrafine particles, the step (B2) is a step for mixing the solution in which the water-soluble ligand L is dissolved into a solvent composed of an alcohol and/or water, with the crystals of the Prussian blue-type metal complex as synthesized in the step (A). Examples of the alcohol include lower alcohols, such as methanol, ethanol, and propanol, with the preference is given to methanol.

By adding water to the solid material obtained after the separation of the above alcohol, it is possible to give an aqueous dispersion liquid of the dispersed ultrafine particles of the Prussian blue-type metal complex. Alternatively, it is also possible to obtain the aqueous dispersion liquid of the dispersed ultrafine particles of the Prussian blue-type metal complex by adding the crystals of the Prussian blue-type metal complex obtained in the step (A), directly to the aqueous solution of the ligand L, followed by stirring the resultant mixture. In this case, it is preferably to use an alcohol solvent, from the viewpoints of the stability and yield of the Prussian blue-type metal complex ultrafine particles to be obtained.

The step (C) is a step for separating the Prussian blue from the solvent, if necessary. For example, when the ultrafine particles of the Prussian blue-type metal complex are dispersed in a solvent, the separation can be conducted by the distillation of the solvent under reduced pressure. When the ultrafine particles are not dispersed, the separation of the solvent may be conducted by filtration or centrifugation. In the case that a mixed solution is obtained via the step (B1), the aggregated ultrafine particles may be obtained as a solid powder by the separation of the organic solvent. In the case that a mixed liquid is obtained via the step (B2), the aggregated ultrafine particles that are water dispersible, can be obtained as a solid powder, by the removal and separation of the solvent composed of an alcohol and/or water. Thus, the desired ultrafine particles can be obtained by isolating and separating from the solvent utilized in the preparation, and can be re-dispersed in another solvent, as required.

Further, in the preparation of the dispersion liquid in which the above-described ultrafine particles of a Prussian blue-type metal complex are dispersed, an additive may be added appropriately. By the action of the additive, another physical property(s) can be provided to the resultant Prussian blue-type metal complex ultrafine particles. It is preferable to add, for example, ammonia, pyridine, or a combination thereof, as a agent for controlling the optical properties, in the course of the preparation of the Prussian blue-type metal complex ultrafine particles, thereby to control the optical properties of the resultant product, depending on the presence or absence of or the amount of the additive to be added. It is preferable that the optical property-controlling agent is added in the step (A). The amount of the optical property-controlling agent to be added is not limited, but it is preferable to add the agent so that the amount thereof would be 10% to 200% to the metal atom M₂, in terms of molar ratio.

Furthermore, as mentioned in the above, as the metal atom M₁ and/or the metal atom M₂, the combination of the two or more kinds of metals may be used, respectively. By adjusting the composition of the metals, it is possible to change the optical properties of the resultant Prussian blue-type metal complex ultrafine particles, thereby to display an image under controlling subtle coloration with the difference of colors. Specifically, for example, it is preferable to use the combination of iron and nickel as the metal atom M₂ in (Fe₁₋ₓNiₓ)₃[Fe(CN)₆]₂, thereby to control the properties of the ultrafine particles by changing the composition (i.e. “x” in the formula).

In this connection, in the step (A), by adding a raw material compound containing target metals with the target mixing ratio, it is possible to obtain the Prussian blue-type metal complex-ultrafine particles having the target metal composition. It should be noted that, with respect to the stirring-extraction method, reference can also be made to the specifications of Japanese Patent Application No. 2006-030481 and International Patent Application No. PCT/JP2006-302135, etc. The Prussian blue-type metal complex, obtained by the stirring-extraction method, exhibits excellent dispersion stability (e.g., a stable dispersion state can be maintained with the lapse of several months or longer) to a variety of solvents (in the present invention, the term “solvent” is used to include a “dispersion medium”), it is favorable for forming a film, and it can be utilized in providing an excellent electrochromic device.

### <Reversed Micelle Method>

A reversed micelle method refers to a method of preparing a dispersion liquid of complex-ultrafine particles coated with an alkyl protecting agent, and includes the following three steps.

(i) A step of separately preparing a first reversed micelle solution containing a metal cyano complex (anion) with the metal atom M₁ as a central metal, and a second reversed micelle solution containing a metal complex cation with the metal atom M₂ as a central metal.

(ii) A step of mixing the first reversed micelle solution and the second reversed micelle solution.

(iii) A step of adding a long-chain alkyl protecting agent L to the mixed liquid obtained in the step (ii), and, as required, isolating the thus-obtained nano-sized crystals.

The metal atoms M₁ and M₂, the counter ion, and the protecting ligand L, each of which can be used in the reversed micelle method, have the same meaning as those which are described for the stirring extraction method, and the preferable examples thereof are also the same. In the following, a further specific description will be given with respect to each of above-mentioned steps.

### Step (i)

In this step, the first reversed micelle solution containing the metal complex anion with the metal atom M₁ as a central metal, and the second reversed micelle solution with the cation of the metal atom M₂ are separately prepared.

It is preferable to prepare a first solution containing the metal complex anion with M₁ as a central metal beforehand as the first reversed micelle solution, and the first solution is obtained by dissolving the above-mentioned metal complex anion in water. The concentration (number of moles of the metal atom with respect to the total amount of the solution) of the first solution is preferably 0.1 to 1 mol/L. Then, the first solution and an organic solvent (cyclohexane, hexane, isooctane, etc.) in which the reversed micelle-forming agent is dissolved are mixed, to thereby obtain the first reversed micelle solution. Examples of kinds of the reversed micelle-forming agent include AOT (sodium di-2-ethylhexylsulfosuccinate) or NP-5 (polyethylene glycol mono-4-nonyl phenyl ether). The amount to be used of the reversed micelle-forming agent is adjusted to a concentration at which the first solution solubilizes as a reversed micelle. In general, it is preferable to adjust the molar ratio of water to the reversed micelle-forming agent (w=[Water]/[AOT or NP-5]) to 5 to 50.

In the case of the second reversed micelle solution, a second solution containing the cation of the metal atom M₂ is prepared in the same manner as in the first solution, and the second solution and an organic solvent in which the reversed micelle-forming agent is dissolved are mixed, thereby to obtain the second reversed micelle solution. It is preferable that the second solution be an aqueous solution of a metal salt (CoCl₂, Fe(NO₃)₃, etc.) containing the metal atom M₂. The preferable ranges of the concentration (number of moles of the metal atom relative to the total amount of the solution) of the second solution, the kind and amount to be used of the reversed micelle-forming agent, and an organic solvent are the same as those of the first reversed micelle solution. The volume of the organic solvent is not particularly limited, and is preferably about 10 to 100 ml.

### Step (ii)

In this step, the first reversed micelle solution and the second reversed micelle solution are mixed. Through the mixing, nano-sized crystals of the metal complex are formed. The generation speed of the nano-sized crystals can be adjusted with the concentrations of the above-mentioned solutions, the concentration of the reversed micelle-forming agent, etc. A mixing method is not limited, and a usual mixer can be used. It is preferable that the mixing ratio of the first reversed micelle solution and the second reversed micelle solution be adjusted in such a manner that a ratio of (the metal complex anion):(the metal cation) would be about 1:0.7 to 1:1.3, in terms of molar ratio.

Step (iii)

In this step, a protecting ligand compound is added to the mixed liquid obtained in the step (ii). The protecting ligand is as described in detail in the description of the stirring-extraction method.

By the above-mentioned fine-particle synthesizing methods, a dispersion liquid with nanometer-scale ultrafine metal complex particles protected by a predetermined protecting ligand can be obtained. The concentration of the dispersion liquid is not limited, and, for example, an about 50-mg/ml dispersion liquid is mentioned as a standard. The dispersion liquid can be suitably adjusted before use, to a desired concentration, in view of a film thickness, a density of color to be displayed, an intended use, etc.

Next, the reversibly color changeable film layer will be described.

In the electrode member for a reversibly color changeable display device of the present invention, the reversibly color changeable film layer refers to a film layer made via coating of a liquid, which layer is obtained by forming a film from the above-mentioned ultrafine particle dispersion liquid. The reversibly color changeable film layer may be subjected to treatment, such as washing and heating, which will be described later. In the film, each ultrafine particle does not need to maintain the shape at the time of the film fabrication, and the ligand L may be adjusted by removing. Moreover, another kind of material may be added for improving optical properties and electrochemical properties. Specifically, an agent for controlling electrochemical properties and/or an agent for controlling color-development properties, such as ferrocene and Nafion, may be added. Further, use may be made of multilayered film layers, at least including a layer in which the agent for controlling electrochemical properties and/or the agent for controlling color-development properties are/is contained, and a layer in which nano-sized fine-particles are contained. The reversibly color changeable film layer is preferably formed by a film-forming method by coating with a dispersion liquid. Specific examples include a spin coating method, a spraying method, an ink jet method, and a printing method (a screen printing method, a transfer printing method, a letterpress printing method, a softgraphy printing method, etc.). The spin coating method or the printing method is more preferable. The thickness of the reversibly color changeable film layer is not limited, and is preferably 1×10⁻⁸ to 1×10⁻⁶ m, and more preferably 2×10⁻⁸ to 5×10⁻⁷ m. Further, it is preferable that the reversibly color changeable film layer have a uniform thickness, and have a reduced surface unevenness. Thus, a color can be displayed while suppressing unevenness in an image.

With respect to the electrode member of the present invention for a reversibly color changeable display device, at the time of or after the formation of the reversibly color changeable film layer by coating with a dispersion liquid containing the Prussian blue-type metal complex-ultrafine particles in which the protecting ligand has been coordinated, it is preferred to perform a treatment, such as washing and/or heating. Specifically, examples include washing with a treatment agent such as acetone, and heat-treatment (preferably heating at 100 to 150° C.). Through this treatment, the amount of the protecting ligand in the Prussian blue-type metal complex-ultrafine particles can be adjusted by removing the ligand, thereby to improve, for example, the electrochemical responsiveness to color change. As described above, a film can be formed by stably dispersing ultrafine particles in a solvent using a desired protecting ligand, and thereafter, in order to enhance the electrochromic performance (response speed, repeat resistance, etc.), the ligand L can be adjusted by removing. Thus, both of the improvement in production quality and the improvement in product quality can be achieved.

The reversibly color changeable film layer can be formed by coating with a dispersion liquid containing the Prussian blue-type metal complex-ultrafine particles. The protecting ligand L to be contained in the layer may coordinate to the Prussian blue-type metal complex or may be a free molecule from which the coordinate bond is desorbed. The amount of the protecting ligand L to be contained in the film layer of ultrafine particles is not limited, and it may be adjusted by removing by the above-mentioned washing, heat-treatment, etc., at the time of or after the film formation. When the amount is excessively large, it is preferable to, for example, adjust the content of the protecting ligand to 10 times or lower (mass ratio) the amount of the Prussian blue-type metal complex. When further reducing the amount for controlling device performances, it is more preferable to adjust the above-mentioned content to 1 time or lower (mass ratio) the amount of the Prussian blue-type metal complex, and particularly preferable to 1/10 or lower (mass ratio) of the amount of the Prussian blue-type metal complex. There is no lower limit on the content of the protecting ligand L. For example, when the protecting ligand L is removed by the above-mentioned treatment or the like, the protecting ligand L may inevitably remain (e.g., about 1/100 in the above-mentioned mass ratio). It should be noted that it is preferable for the reversibly color changeable film layer and a dispersion liquid for forming the film not to contain a high molecular weight compound whose average degree of polymerization is 50 or higher.

The electrode member for a reversibly color changeable display device of the present invention and the reversibly color changeable device using the same can achieve multi-colorization, and their performances are remarkably superior to the conventional ones. Moreover, the color of the reversibly color changeable film layer can be reversibly changed under electrical control.

With respect to the reversibly color changeable display device of the present invention, because the ultrafine particles coordinated by the protecting ligand coordinates as required are used, the ultrafine nano-sized particles are uniformly and stably dispersed in water or various organic solvents and a high-precision homogeneous film layer having a uniform thickness can be formed, an even and fine image can be displayed, and a subtle color can be controlled. Further, the protecting ligand coordinated to the ultrafine particles can be suitably removed at the time of or after the film formation, thereby to control the electrochemical responsiveness and the like. Further, both of the production quality at the time of the film formation and the product quality on the reversibly color changeable display performance can be achieved.

Further, the method of producing the electrode member for a reversibly color changeable display device of the present invention exhibits such excellent effects as the processing time and the number of processes are reduced, and the precise film processing and/or the ultrafine processing can be readily and accurately performed.

The present invention will be described in more detail based on the following examples, but the invention is not construed to be limited thereto.

### EXAMPLES

### Preparation Example 1

### (A) Synthesis of Prussian Blue Bulky Form

An aqueous solution in which 1.0 g of (NH₄)₄[Fe(CN)₆] was dissolved in water, and an aqueous solution in which 1.4 g of Fe(NO₃)₃·9H₂O was dissolved in water were mixed, to precipitate fine-crystals of a Prussian blue. By centrifuging, water-insoluble Prussian blue fine-crystals were separated off, followed by washing with water three times and washing with methanol twice, and then drying under reduced pressure.

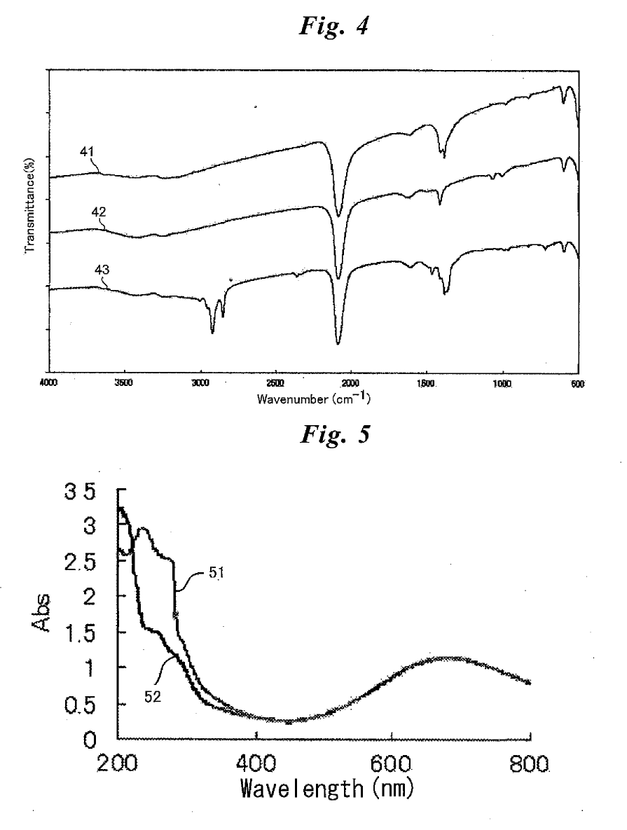

The thus-prepared Prussian blue bulky form was analyzed with a powder X-ray diffractometer. The measurement results are shown in a chart 31 of FIG. 3(II). This chart is consistent with the peak pattern of the Prussian blue which was in the standard sample database (see the peak pattern shown in FIG. 3(I)). Furthermore, in the FT-IR measurement, the peak specific to Fe-CN stretching vibration was observed at about 2,070 cm⁻¹ (see the spectrum 41 of FIG. 4). These results reveal that the obtained solid material was a Prussian blue.

### (B1) Preparation of Dispersion Liquid of Organic Solvent-Dispersible Prussian Blue Ultrafine-Particles

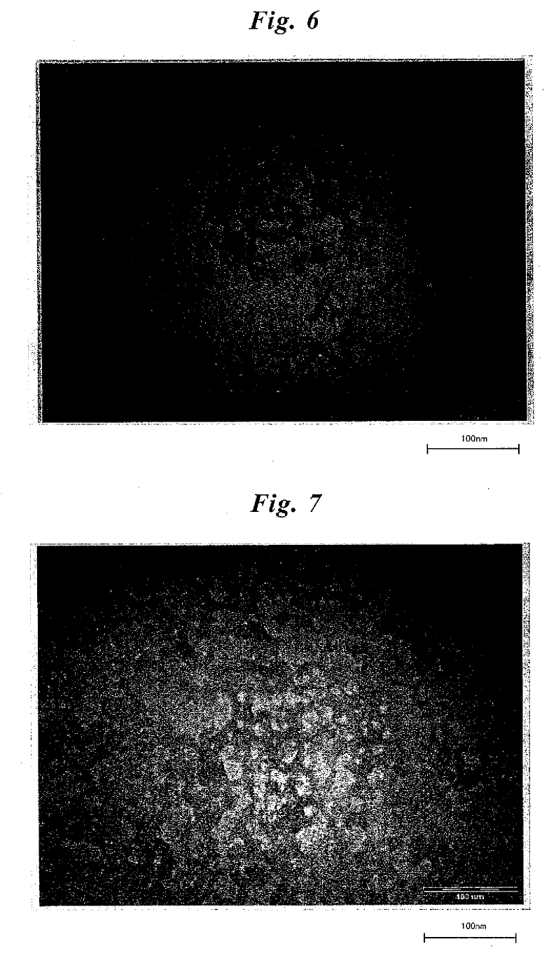

To 5 ml of a toluene solution in which a ligand oleylamine having a long-chain alkyl group was dissolved, as a ligand L, 0.5 ml of water was added. Then, to the resultant solution, 0.2 g of the Prussian blue bulky form synthesized in (A) was added. After the resultant mixture was stirred for 1 day, all Prussian blue fine-particles were dispersed in the toluene phase, to yield a deep blue-coloured dispersion liquid. The toluene phase was separated from the aqueous phase, and successively the deep blue toluene phase was filtrated, to yield a dispersion liquid of Prussian blue fine-particles (the results of FT-IR measurement of the dispersion liquid are shown in a chart 43 of FIG. 4.). The results of measurement of UV-visible absorption spectrum of the dispersion liquid are shown in a spectrum 51 of FIG. 5. It is known that the peak around 680 nm originates from an absorption by charge transfer between Fe and Fe of Prussian blue, and the results revealed that the fine-particle dispersion liquid contained a Prussian blue. Further, FIG. 6 shows the observation results, by transmission electron microscopy, of the dispersion liquid of the Prussian blue ultrafine-particles having oleylamine as a protecting ligand. From FIG. 6, it is confirmed that the ultrafine particles having an average particle diameter of about 10 to 15 nm were synthesized. The Prussian blue bulky form did not remain in the aqueous phase and almost all of the bulky form was able to extract into the toluene phase as ultrafine particles.

### (C1) Separation and Re-Dispersion Liquid of Solid Powder of Prussian Blue Ultrafine-Particle Aggregation

From the dispersion liquid obtained in (B1), toluene was removed by evaporation to dry under reduced pressure, to yield a solid powder almost quantitatively. The thus-obtained solid powder readily was readily re-dispersed in an organic solvent, such as dichloromethane, chloroform, or toluene, to yield a deep blue transparent dispersion liquid.

The thus-obtained Prussian blue ultrafine-particle solid powder was analyzed with a powder X-ray diffractometer. The analyzed results reveal that the XRD pattern of the sample was consistent with the peak positions of the Prussian blue in the standard sample database (see a chart 33 in FIG. 3). A peak at a lower angle side was a broad background due to oleylamine contained in excess.

### Preparation Example 2

### (A) Synthesis of Prussian Blue Bulky Form

A Prussian blue bulky form was synthesized in the same manner as in Preparation Example 1.

### (B2) Preparation of Dispersion Liquid of Water-Dispersible Prussian Blue Ultrafine-Particles

To 5 ml of a methanol solution in which 2-aminoethanol was dissolved as a ligand L, 0.2 g of the Prussian blue bulky form synthesized in (A) was added, and the resultant mixture was stirred for about 3 hours, to give a dispersion liquid of Prussian blue-type metal complex-ultrafine particles. After the stirring, the resultant ultrafine particles existed as solid, without dissolving in methanol. The FT-IR measurement results of the ultrafine particles are shown as a chart 42 in FIG. 4.

### (C2) Separation and Re-Dispersion of Solid Powder of Prussian Blue Ultrafine-Particle Aggregation

The methanol in the dispersion liquid obtained in (B2) was removed off, followed by separation, to give a solid powder α. To the solid powder a, water was added, and all the solid powder was dispersed in water, to give a deep blue-coloured transparent dispersion liquid β.

FIG. 7 shows the observation results, by transmission electron microscopy, of the dispersion liquid β (the solvent was water) of the thus-obtained Prussian blue ultrafine-particles having 2-aminoethanol as a protecting ligand. From FIG. 7, it is confirmed that the ultrafine particles having an average particle diameter of about 10 to 15 nm were synthesized. Further, from the UV-visible absorption spectrum measurement of the dispersion liquid, the peak specific to Prussian blue at 680 nm was observed, similar to the case in the above-mentioned organic solvent ultrafine-particle dispersion liquid (see a spectrum 52 in FIG. 5). From those measurement results, it is understood that an aqueous dispersion liquid of Prussian blue ultrafine-particles was obtained.

The solid powder a obtained in the operation procedure (B2) was analyzed with a powder X-ray diffractometer. From the analysis results (see a spectrum 32 in FIG. 3), the peak of Prussian blue was identified. The results of the analysis of peak half-height width revealed that the average particle diameter of the crystals was about 10 to 20 nm. From those results, it is understood that the solid powder cc was Prussian blue nano-sized particle aggregation.

### Preparation Example 3

To 1.5 ml of an aqueous solution of 0.329 g (0.999 mmol) of potassium ferricyanate (or potassium ferricyanide), K₃[Fe(CN)₆], 0.1 ml of ammonia water NH₃ (28.0%, 14.8 N) was added, and thereto 1.0 ml of an aqueous solution of 0.437 g (1.50 mmol) of cobalt nitrate Co(NO₃)₂·6H₂O was added, and the resultant mixture was stirred for about 3 minutes. Then, by subjecting to centrifugation, crystals of a Prussian blue-type metal complex were obtained as a red precipitation. The crystal precipitation was washed with water three times, and with methanol once. The yield was 0.631 g and 105% (it was presumed that the yield over 100% was an error due to inclusion of water since the drying was insufficient.).

To 3.0 ml of a toluene solution of 0.443 g (1.66 mmol, 100% (molar ratio) of the total metal amount) of oleylamine, 0.204 g (0.340 mmol) of the precipitation of the Prussian blue-type metal complex crystals (cobalt ferricyanide complex crystals) obtained in the foregoing synthesis was added, and the resultant mixture was stirred for about 1 day. Thus, Prussian blue-type metal complex-ultrafine particles were obtained in a dispersion liquid. The dispersion liquid, obtained under the condition that ammonia was added, was named a dispersion liquid sample γ.

Then, the toluene was removed from the dispersion liquid sample y by evaporation to dryness under reduced pressure, to yield Prussian blue-type metal complex-ultrafine particles as a solid aggregation separated.

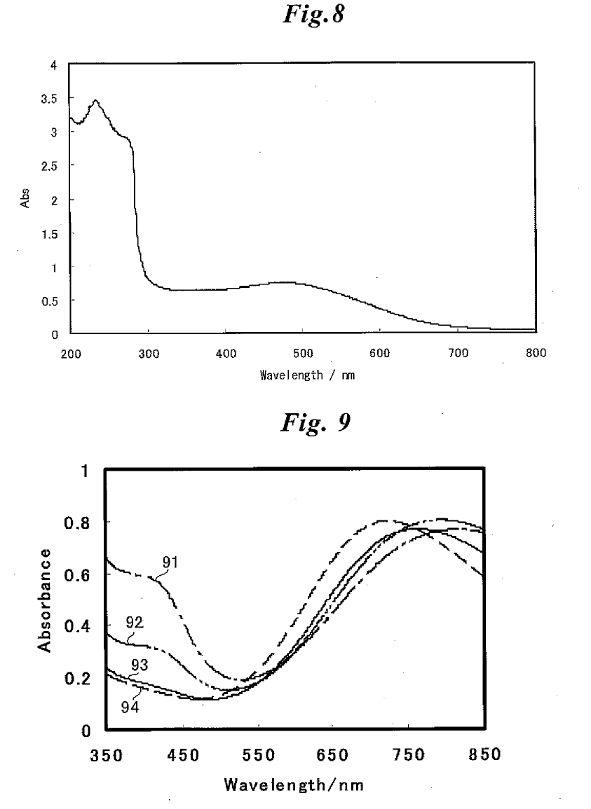

The dispersion liquid sample y was subjected to centrifugation, and a part of the supernatant was taken off and diluted with toluene, followed by UV-Vis optical measurement. The absorption maximal value in the visible region of that sample was present at 480 nm (see FIG. 8), which is different from the maximum position at 520 nm of a sample obtained without ammonia being added. This different can be distinguishable with the naked eye, and the sample without ammonia being added exhibited a purplish color, but the sample obtained by adding ammonia exhibited an enhanced red color.

From those results, it is understood that the optical property of Prussian blue-type metal complex-ultrafine particles can be controlled, by changing the optical spectrum thereof, using addition of ammonia.

### Preparation Example 4

### (Synthesis of (Fe_{0.2}Ni_{0.8})₃[Fe(CN)₆]₂)

An aqueous solution (2 ml) of K₃[Fe(CN)₆] (0.658 g (2.00×10⁻³ mol)) was added to a mixed solution of an aqueous solution (0.4 ml) of FeSO₄·7H₂O (0.167 g (6.00×10⁻⁴ mol)) and an aqueous solution (1.6 ml) of Ni(NO₃)₂·6H₂O (0.698 g (2.40×10⁻³ mol)), under stirring. The resultant precipitate was centrifugally washed with distilled water three times and with methanol once, followed by air-drying, to obtain crystals of Prussian blue-type metal complex having the target metal composition.

### (Synthesis of (Fe_{0.4}Ni_{0.6})₃[Fe(CN)₆]₂)

An aqueous solution (2 ml) of K₃[Fe(CN)₆] (0.658 g (2.00×10⁻³ mol)) was added to a mixed solution of an aqueous solution (0.8 ml) of FeSO₄·7H₂O (0.334 g (1.20×10⁻³ mol)) and an aqueous solution (1.2 ml) of Ni(NO₃)₂·6H₂O (0.523 g (1.80×10⁻³ mol)), under stirring. The resultant precipitate was centrifugally washed with distilled water three times and with methanol once, followed by air-drying, to obtain crystals of Prussian blue-type metal complex having the target metal composition.

### (Synthesis of (Fe_{0.6}Ni_{0.4})₃[Fe(CN)₆]₂)

An aqueous solution (2 ml) of K₃[Fe(CN)₆] (0.658 g (2.00×10⁻³ mol)) was added to a mixed solution of an aqueous solution (1.2 ml) of FeSO₄·7H₂O (0.500 g (1.80×10⁻³ mol)) and an aqueous solution (0.8 ml) of Ni(NO₃)₂·6H₂O (0.349 g (1.20×10⁻³ mol)), under stirring. The resultant precipitate was centrifugally washed with distilled water three times and with methanol once, followed by air-drying, to obtain crystals of Prussian blue-type metal complex having the target metal composition.

### (Synthesis of (Fe_{0.8}Ni_{0.2})₃[Fe(CN)₆]₂)

An aqueous solution (2 ml) of K₃[Fe(CN)₆] (0.658 g (2.00×10⁻³ mol)) was added to a mixed solution of an aqueous solution (1.6 ml) of FeSO₄·7H₂O (0.667 g (2.40×10⁻³ mol)) and an aqueous solution (0.4 ml) of Ni(NO₃)₂·6H₂O (0.174 g (5.98×10⁻⁴ mol)), under stirring. The resultant precipitate was centrifugally washed with distilled water three times and with methanol once, followed by air-drying, to obtain crystals of Prussian blue-type metal complex having the target metal composition.

To 0.10 g of any one of the four kinds of (Fe₁₋ₓNiₓ)₃[Fe(CN)₆]₂ synthesized in the above, 0.2 ml of water was added, the resultant aqueous solution was mixed with 2 ml of a toluene solution of 0.090 g (3.4×10⁻⁴ mol) of oleylamine, followed by stirring for 1 day, to give a dispersion liquid of Prussian blue-type metal complex ultrafine-particles. Then, subjecting to centrifugation and separation of the toluene layer, the ultrafine particles having the target metal composition were obtained by separation. With respect to the thus-obtained four kinds of the Prussian bluetype metal complex ultrafine-particles, absorption spectrum was measured, respectively. The results are shown in FIG. 9. In FIG. 9, the curve 91 shows the results of the Prussian blue-type metal complex ultrafine-particles in which x=0.8 in the chemical structural formula; the curve 92 shows the results of one in which x=0.6; the curve 93 shows the results of one in which x=0.4; and the curve 94 shows the results of one in which x=0.2.

Based on the thus-obtained UV-Vis absorption spectra, it is understood that the wavelengths at the absorption bands of the charge transfer (CT) between Fe—Fe were systematically shifted to the longer wavelength side, in accordance with the nickel content. Further, the intensity of the absorption band around 400 nm derived from Fe—CN—Ni also enhanced systematically. From those results, it is understood that Ni and Fe were homogeneously distributed in an individual nano-sized particle (ultrafine particle), and that it is possible to control the change in subtle coloration by adjusting the metal composition (x) of the metals to be combined. To the contrary with respect to (powder on ultrafine particles to be obtained, if Ni and Fe are distributed heterogeneously in an individual crystal, or if ultrafine particles to be obtained are a mere mixture of ultrafine particles of Ni₃[Fe(CN)₆]₂ and Fe₄[Fe(CN)₆]₃, the systematic shifting of the wavelength at the above-mentioned Fe-Fe charge transfer absorption band cannot be observed.

### Preparation Example 5

Then ,the Prussian blue-type metal complex ultrafine particles were prepared in the same manner as in Preparation Example 1 for the Samples 1 to 16 and in the same manner as in Preparation Example 2 for the Samples 17 to 19, excepted that the metal atoms M₁ and M₂, the ligand L, and the dispersion medium were appropriately changed to those listed in the following table; and the respective dispersion liquid was prepared in which the ultrafine-particles were dispersed in the respective dispersion medium as shown in the table. Further, the ultrafine-particulate dispersion liquids were prepared in the same manner as in the above, excepted that the Sample 20 utilized the ultrafine particles prepared in Preparation Example 3, that the Sample 21 utilized the ultrafine particles prepared in Preparation Example 4, and that the Sample 22 utilized the ultrafine particles prepared by using butyl acetate instead of oleylamine in Preparation Example 1, respectively. As can be seen from those results, it is understood that it is possible to produce a variety of Prussian blue-type metal complex ultrafine particles.

TABLE 1

| Sample | M₁ | M₂ | L | Dispersion medium | Additive |
|---|---|---|---|---|---|
| 1 | Fe | Fe | oleylamine | toluene | none |
| 2 | Fe | Fe | oleylamine | dichloromethane | none |
| 3 | Fe | Fe | oleylamine | chloroform | none |
| 4 | Fe | Fe | oleylamine | hexane | none |
| 5 | Fe | Fe | oleylamine | diethyl ether | none |
| 6 | Fe | Fe | stearylamine | toluene | none |
| 7 | Fe | Fe | stearylamine | dichloromethane | none |
| 8 | Fe | Fe | stearylamine | chloroform | none |
| 9 | Fe | Fe | 4-di-octadecyl- | toluene | none |
| | | | aminopyridine | | |
| 10 | Fe | Fe | 4-di-octadecyl- | dichloromethane | none |
| | | | aminopyridine | | |
| 11 | Fe | Fe | 4-di-octadecyl- | chloroform | none |
| | | | aminopyridine | | |
| 12 | Fe | Fe | 4-octadecyl- | toluene | none |
| | | | aminopyridine | | |
| 13 | Fe | Co | oleylamine | toluene | none |
| 14 | Fe | Co | stearylamine | toluene | none |
| 15 | Fe | Co | 4-di-octadecyl- | toluene | none |
| | | | aminopyridine | | |
| 16 | Fe | Ni | oleylamine | toluene | none |
| 17 | Fe | Fe | 2-aminoethanol | water | none |
| 18 | Fe | Co | 2-aminoethanol | water | none |
| 19 | Fe | Fe | 2-(2-aminoethoxy)- | water | none |
| | | | ethanol | | |
| 20 | Fe | Co | oleylamine | toluene | ammonia |
| 21 | Fe | Fe, | oleylamine | toluene | none |
| | | Ni | | | |
| 22 | Fe | Fe | butyl acetate | toluene | none |

In each of the preparation examples in the table, the whole complex crystals as synthesized in the step (A) were almost converted into complex fine-particles. That is, it is possible to give almost 100% for the yield of the ultrafine particles, by adjusting the preparation ratio so that the materials for synthesizing the target complex crystals would be just enough for the preparation.

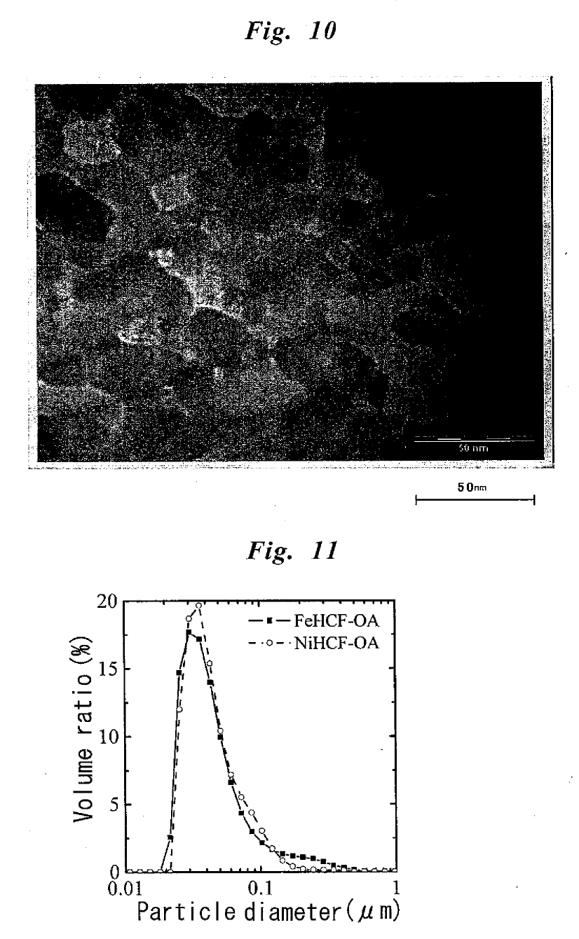

In the preparation process for Prussian blue-type metal complex crystals in the step (A), other raw material compounds may be used, but not limited to those mentioned in the above. For example, in the case of Prussian blue, the target Prussian blue-type metal complex ultrafine-particles can be obtained in the same manner as above, not only by the mixing of (NH₄)₄[Fe(CN)₆] with Fe(NO₃)₃·9H₂O, but also by the mixing of an aqueous solution in which 1.0 g of K₃[Fe(CN)₆] was dissolved in water with an aqueous solution in which 0.84 g of FeSO₄·7H₂O was dissolved in water, or by the mixing of an aqueous solution in which 1.0 g of Na₄[Fe(CN)₆]·10H₂O was dissolved in water with an aqueous solution in which 0.83 g of Fe(NO₃)₃·9H₂O (0.83 g) was dissolved in water. Furthermore, as already mentioned in the above, the metals atoms M₁ and M₂ are not limited to Fe. FIG. 10 shows a TEM image of cobalt ferricyanide complex ultrafine particles, which were prepared from [Fe(CN)₆]³⁻ and Co²⁺.

The dispersion liquid of the Prussian blue-type metal complex-ultrafine particles (FeHCF-OA), which was prepared in Preparation Example 1, and the dispersion liquid of the Prussian blue-type metal complex-ultrafine particles (NiHCF-OA) of Sample No. 16 in Table 1, were subjected to particle size distribution measurement (using a micro truck UPA-EX150, manufactured by NIKKISO CO., LTD), respectively. The measurement results are shown in FIG. 11. The peak of the particle diameter appears at 30 to 40 nm, which is larger than a particle diameter observed under an electron microscope or the like. This is because a plurality of particles aggregated and moved in a solvent, and the particle diameter of a secondary particle was shown.

### Example 1-1

A dispersion liquid of Sample No. 1 of Table 1, was prepared, in detail, prepared was a dispersion liquid in which 104 mg of powder of FeHCF-OA ultrafine particles (hereinafter, the Prussian blue-type metal complex-ultrafine particles in which M₁=Fe, M₂=Fe, and L=oleylamine, is referred to as “FeHCF-OA ultrafine particles”) was dispersed in 4 mg of toluene. The thus-obtained dispersion liquid was coated, by a spin coating method at room temperature, on a glass substrate that had been coated with ITO (rectangular glass substrate of length 25 mm, width 25 mm, and thickness 1 mm), to form a reversibly color changeable film layer, and an electrode member for a reversibly color changeable display device of the present invention was made with the film layer. At that time, the spin coating was performed after the dispersion liquid was added dropwise on the substrate, by rotating at a rotational rate of 400 rpm for 30 seconds, and then at a rotational rate of 1,000 rpm for 10 seconds.

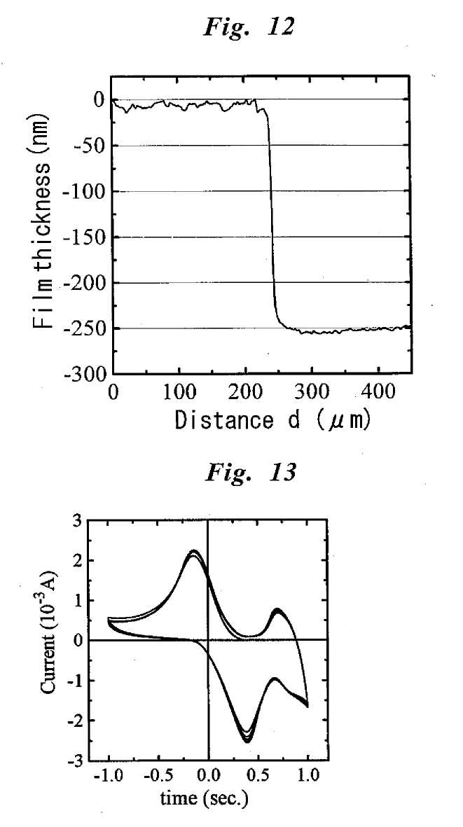

The thickness of the resultant film layer was measured using a stylus thickness-measuring device. In FIG. 12, a region in which the distance d is less than 250 μm is a region in which the reversibly color changeable film layer existed, and a region in which the distance d is more than 250 μm is a region in which the film layer was removed. This shows that a coated film layer having a uniform thickness was obtained, considering that the film thickness of the film layer was about 250 nm and the position dependence of the film thickness remains at 10 to 20 nm.

The thus-obtained electrode member was subjected to cyclic voltammetry measurement, and the measurement results are shown in FIG. 13. SCE was used as a reference electrode, a platinum electrode was used as a counter electrode, and 0.1 M Na₂SO₄ was used as an electrolyte. This shows that the oxidation-reduction state of the film layer can be operated through an electrochemical reaction. Moreover, the color of the ultrafine particles changed only in a region in contact with the ITO-coated region, i.e., a region in contact with the electrode. As a result of observation of the change in the color through the application of voltage, when a voltage of 1.5 V was applied, the ultrafine particles were colorless and transparent and when a voltage of 1.0 V was applied, the ultrafine particles exhibited a blue color.

### Example 1-2

A dispersion liquid of Sample No. 16 of Table 1 was prepared. In detail, the dispersion liquid was prepared by dispersing 102 mg of powder of NiHCF-OA ultrafine particles into 1 mg of toluene (hereinafter, the Prussian blue-type metal complex-ultrafine particles in which M₁=Fe, M₂=Ni, and L=oleyiamine, is referred to as “NiHCF-OA ultrafine particles”). To form a reversibly color changeable film layer, the obtained dispersion liquid was coated by a spin coating method at room temperature on a glass substrate that had been coated with ITO (rectangular glass substrate of length 25 mm, width 25 mm, and thickness 1 mm). This was an electrode member for a reversibly color changeable display device of the present invention. The spin coating was performed after the dispersion liquid was added dropwise on the substrate, by rotating at a rotational rate of 300 rpm for 20 seconds, at a rotational rate of 500 rpm for 20 seconds, and then at a rotational rate of 1,000 rpm for 10 seconds, by continuously rotating at those speeds altering. The thus-obtained spin-coated film was a film layer of ultrafine particles having a uniform thickness.

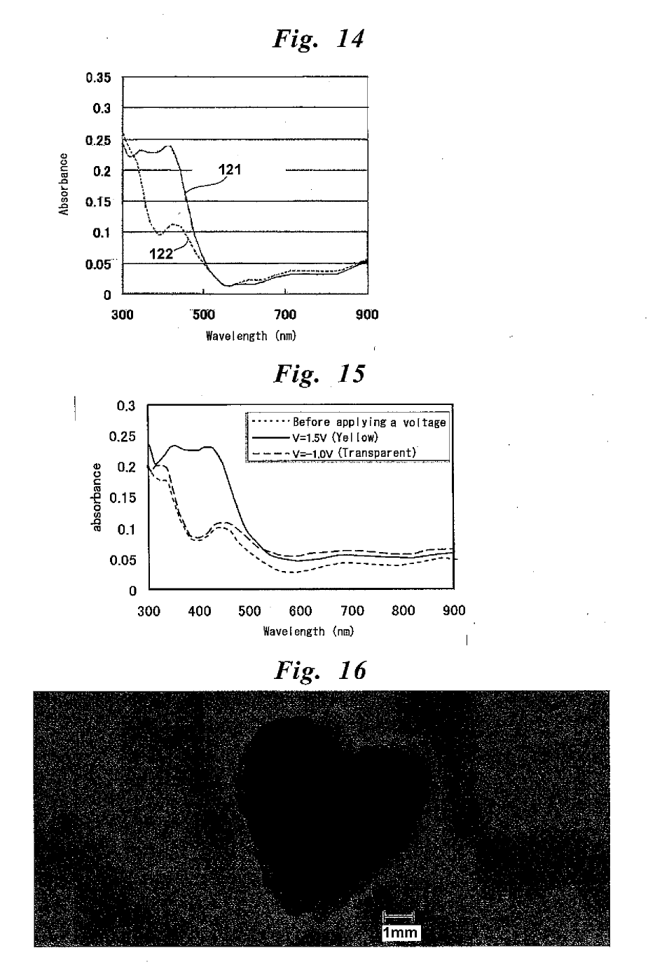

Also with respect to the resultant electrode member, it was possible to control the oxidation-reduction state of the film layer through an electrochemical reaction in the same manner as in Example 1-1. Further, the changes in the absorption spectra through the application of voltage are shown in FIG. 14. Before applying a voltage and at the time of applying a voltage of −1.0 V, no absorption near 450 nm was shown (spectra under those two conditions overlapped as indicated by the dotted line 122 of FIG. 14). The optical properties sharply changed by applying a voltage of 1.5 V and absorption near 450 nm was shown (see the solid line 121 of FIG. 14). Hereinafter, unless otherwise specified, in the case of a positive (+) voltage, a transparent electrode was used as a positive electrode, and in the case of a negative (−) voltage, a transparent electrode was used as a negative electrode. A substance showing absorption near 450 nm looks yellow. It can be understood that the change in the color of yellow/transparent colorless can be electrically controlled, depending on the existence of the peak.

### Example 1-3

A dispersion liquid of Sample No. 16 of Table 1 was prepared. In detail, the dispersion liquid was prepared by dispersing 102 mg of powder of NiHCF-OA ultrafine particles into 1 mg of toluene. The thus-obtained dispersion liquid was coated, by a spin coating method at room temperature, on a glass substrate that had been coated with ITO (length 25 mm, width 25 mm, and thickness 1 mm), to form a reversibly color changeable film layer, and an electrode member for a reversibly color changeable display device of the present invention was made with the film layer. At that time, the spin coating was performed after the dispersion liquid was added dropwise on the substrate, by rotating at a rotational rate of 300 rpm for 20 seconds, at a rotational rate of 500 rpm for 20 seconds, and then at a rotational rate of 1,000 rpm for 10 seconds, by continuously rotating at those speeds altering. Then, 100 mg of ferrocene was dissolved in 2 ml of ethanol, and a film was formed with the resultant solution by spin coating on the film of NiHCF-OA ultrafine particles at room temperature. The spin coating after the ferrocene solution was added dropwise was performed by rotating continuously at a rotational rate of 500 rpm for 30 seconds, and then at a rotational rate of 1,000 rpm for 10 seconds.

With the resultant electrode member, the changes in the absorption spectra when applying a voltage are shown in FIG. 15. The absorption spectrum before the application of voltage is shown by the dotted line, the absorption spectrum when applying a voltage of 1.5 V is shown by the solid line, and the absorption spectrum when applying a voltage of −1.0 V is shown by the dashed line. From the results, it can be understood that even when further coated with ferrocene, no deterioration was observed on the electrochromic properties (rather, as described later, a response speed is remarkably enhanced by coating with ferrocene).

### Example 1-4

A dispersion liquid of Sample No. 1 of Table 1, was prepared, in detail, prepared was a dispersion liquid in which 104 mg of powder of FeHCF-OA ultrafine particles was dispersed in 4 mg of toluene. Then, the dispersion liquid prepared above was applied to a heart-shaped convex rubber support having a dimension which was inscribed in a circle about 8 mm in diameter, and the thus-coated substrate was adhered under pressure to a glass substrate coated with ITO, thereby to form a reversibly color changeable film layer. As shown in FIG. 16, it was possible to form, on the substrate, the electrode member for a reversibly color changeable display device of the present invention having a film of ultrafine particles, which was the same in the shape as the support. This reveals that an electrode member having a reversibly color changeable film layer of a desired shape can be readily formed.

### Example 2-1

According to the procedures, as shown in FIGS. 17-1 to 17-4, a reversibly color changeable display device of the present invention was produced as described below.

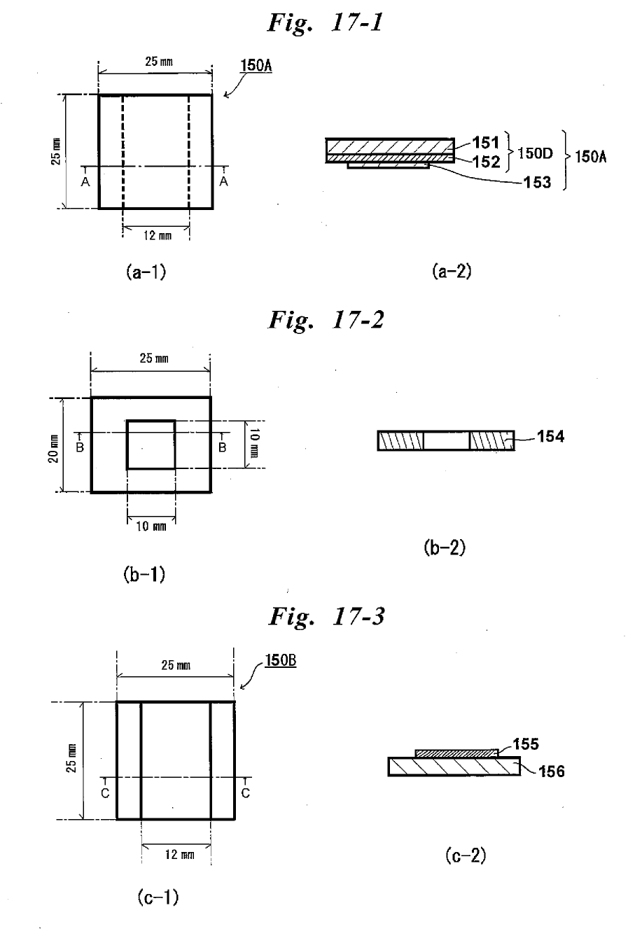

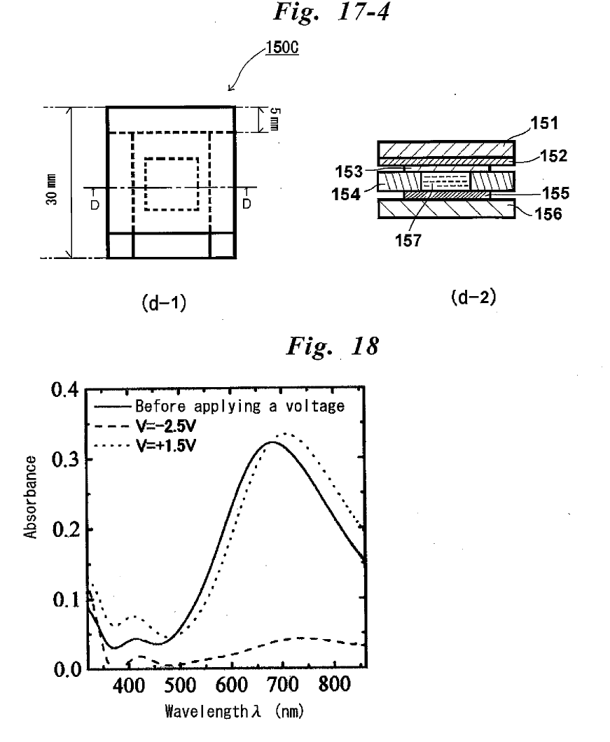

The electrode member for a reversibly color changeable display device as produced in Example 1-1 was provided (FIG. 17-1(a-1) is a plan view schematically illustrating the electrode member, and FIG. 17-1(a-2) is a cross sectional view along the A-A line). The electrode member 150A for a reversibly color changeable display device included the transparent glass substrate 151, the ITO electrically-conductive film 152, and the reversibly color changeable film layer 153. Then, a substance in which a hole was formed in a 100 μm-thick polyester sheet was provided as a sealing material 154 (FIG. 17-2(b-1) is a plan view schematically illustrating the sealing material, and FIG. 17-2(b-2) is a cross sectional view along the B-B line). Further, an electrically-conductive counter electrode structural layer 150B in which a metallic film (ITO electrically-conductive film) 155 was formed on an insulator (glass substrate) 156 was produced (FIG. 17-3(c-1) is a plan view schematically illustrating the electrically-conductive counter electrode structural layer, and FIG. 17-3(c-2) is a cross sectional view along the C-C line).

The electrode member 150A for a reversibly color changeable display device and the sealing material 154 were adhered to each other, and a 1-mM Na₂SO₄ aqueous solution 157 was poured into the hole portion of the sealing material 154 as an electrolyte. Then, the electrically-conductive counter electrode structural layer 150B was adhered thereto, to obtain the reversibly color changeable display device 150C as shown in FIG. 17-4 (FIG. 17-4(d-1) is a plan view schematically illustrating the reversibly color changeable display device produced above, and FIG. 17-4(d-2) is a cross sectional view along the D-D line).

As electrodes, use was made of the transparent metal electrically-conductive film 152 and the metal electrically-conductive film 155 of the above-prepared reversibly color changeable display device, and a voltage was applied to the device, to perform an optical property control test of the device. FIG. 18 shows absorption spectra of the electrochromic device using the FeHCF-OA ultrafine particles before and after the application of voltage. Before applying voltage (solid line in FIG. 18), a large absorption was observed at 500 nm or longer portion, and the device exhibited a blue color. This absorption sharply decreased by applying voltage of −2.5 V (dashed line in FIG. 18). Consequently, the device became transparent colorless. When a voltage of 1.5 V was further applied, the absorption peak was recovered, and the device returned to a blue color (dotted line in FIG. 18). The result reveals that the reversibly color changeable display device of the present invention can be operated while controlling the change in the color of blue/transparent through the application of voltage. Moreover, an image displayed by the reversibly color changeable display device had no unevenness and was clear in definition. Further, after the application of a voltage of 1.5 V, a voltage was shut off and the device was opened, then the blue displayed color was maintained and was recorded at least half a day in the same displaying state.

### Example 2-2

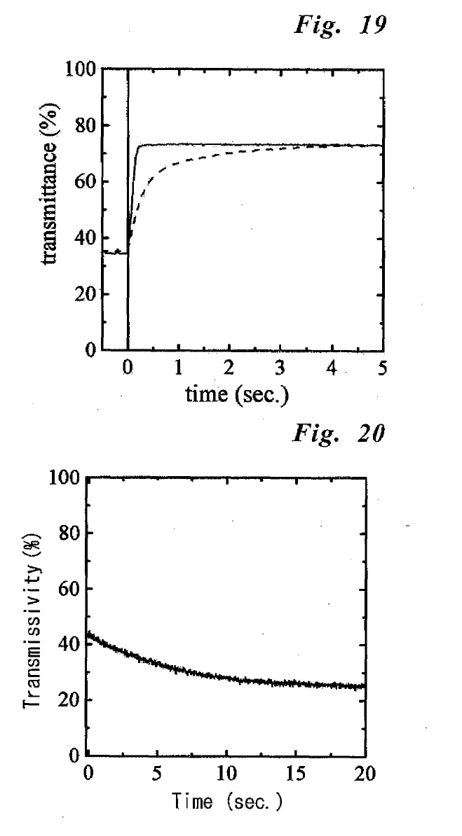

The reversibly color changeable display device of the present invention was produced in the same manner as in Example 2-1, except that the electrode member for a reversibly color changeable display device of Example 1-3 (it should be noted that NiHCF-OA was changed to FeHCF-OA) was used in place of the electrode member for a reversibly color changeable display device as used for the reversibly color changeable display device produced in Example 2-1, The device using multilayered films in which a ferrocene layer was formed on the FeHCF-OA layer, was subjected to a color change measurement test. The results show that the color changing speed was sharply improved. FIG. 19 shows the results (the changes of absorption coefficients with the lapse of time at wavelength 700 nm for each reversibly color changeable display device are shown). In the case of the device produced in Example 2-1 in which no ferrocene layer was used (the dashed line of FIG. 19), it took about 1 second for the absorption coefficient change to complete substantially. In contrast, when the ferrocene layer was used (the solid line of FIG. 19), the color change was substantially completed in about 200 milliseconds. The results reveal that the display performance of the reversibly color changeable display device can be improved, by adding an agent for controlling electrochemical properties to the ultrafine particle layer, or by forming a multilayer structure with the layer. Moreover, an image displayed by the reversibly color changeable display device was had no unevenness and was clear in definition.

### Example 2-3

The reversibly color changeable display device of the present invention was produced in the same manner as in Example 2-1, except that the electrode member for a reversibly color changeable display device as produced in Example 1-2 was used, in place of the electrode member for a reversibly color changeable display device as used for the reversibly color changeable display device produced in Example 2-1. The resultant electrochromic device having the NiHCF-OA ultrafine particle layer was also subjected to absorption and transmission spectrum measurements. As a result, also in this device, electrochemical changes were shown, and the changes in the absorption and transmission spectra through the application of voltage were observed (however, since the reference for the electric potential was not the same, the voltage at which an electrochromic phenomenon occurred was not the same). FIG. 20 illustrates the transmittance at wavelength 420 nm upon applying a voltage of 2.0 V. It can be seen that the transmittance decreases and the color becomes dark by applying a voltage.

### Example 2-4

FeHCF-OA ultrafine particles were synthesized, using iron chloride hexa-hydrate and sodium ferrocyanide decahydrate as raw materials, by the stirring-extraction method in the same manner as in Preparation Example 1. Then, 0.0676 of the resultant ultrafine particles was dispersed in 1 ml of toluene, to give a dispersion liquid of ultrafine particles. With the resultant dispersion liquid of ultrafine particles, spin coating was performed in the same manner as in Example 1-1 (at 500 rpm for 10 seconds, and then 1,000 rpm for 30 seconds), to form a reversibly color changeable film layer, and an electrode member for a reversibly color changeable display device of the present invention was produced by using the film layer. The resultant electrode member was left in acetone for 10 minutes, followed by washing.

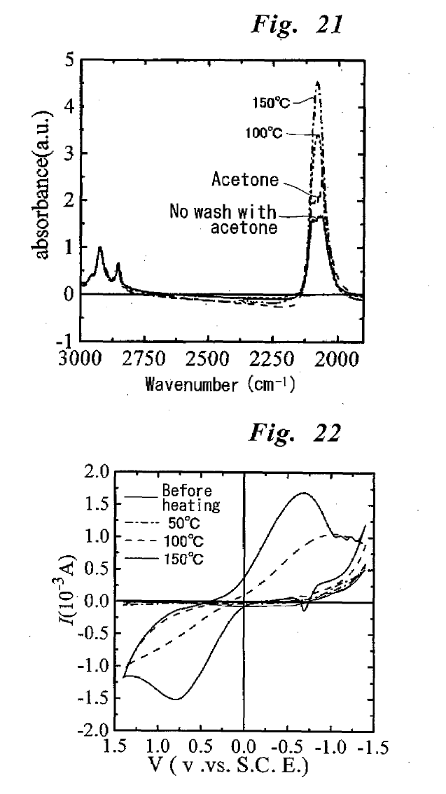

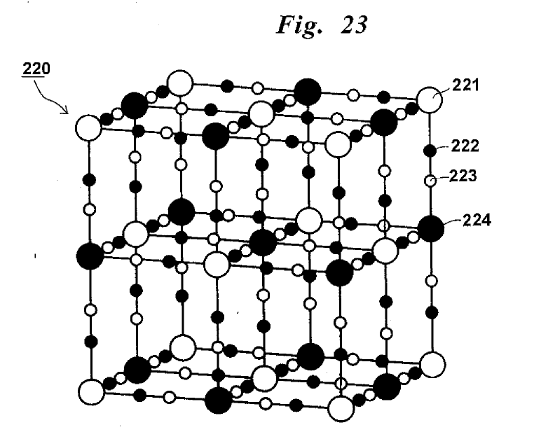

In order to observe the state of the ultrafine particles upon the above treatment, a test piece which was made by adding dropwise the above-mentioned FeHCF-OAfine-particles to a KBr pellet-was subjected to infrared spectroscopy measurement before and after the acetone treatment. The results are shown in FIG. 21. At that time, the origin was corrected to a measurement value at 4,000 cm⁻¹, and then normalization was performed at the peak resultant from CN stretching. The peak near 2,900 cm⁻¹ is caused by the CH stretching of oleylamine which was a protective molecule, and the peak at 2,080 cm⁻¹ is caused by the CN stretching of Prussian blue. It can be seen that the peak intensity of the CH stretching of oleylamine largely decreased by the acetone treatment, as compared with the peak intensity of the CN stretching of Prussian blue.

The electrode member for a reversibly color changeable display device having the reversibly color changeable film layer which was washed with acetone, was subjected to cyclic voltammetry measurement. As a result, electrochemical responsiveness was hardly exhibited in the electrode member before the acetone treatment, but electrochemical responsiveness was exhibited in the electrode member after the acetone treatment. This result shows that the washing with acetone enhanced the electrochemical responsiveness of the electrode member for a reversibly color changeable display device of the present invention.

### Example 2-5

FeHCF-OA ultrafine particles were synthesized, using iron chloride hexa-hydrate and sodium ferrocyanide decahydrate as raw materials, by the stirring-extraction method in same manner as in Preparation Example 1. Then, 0.0676 g of the resultant ultrafine particles was dispersed in 1 ml of toluene, to give a dispersion liquid of ultrafine particles. With the resultant dispersion liquid of ultrafine particles, spin coating was performed in the same manner as in Example 1-1 (at 500 rpm for 10 seconds, and then 1,000 rpm for 30 seconds), to form a reversibly color changeable film layer, and an electrode member for a reversibly color changeable display device of the present invention was produced by using the film layer. Three test pieces of the thus-obtained electrode member were subjected to heat treatment by being left at a high temperature (50° C., 100° C., or 150° C., respectively) for 2 hours.

In order to observe the state of the ultrafine particles upon heating, a KBr sample produced in the same manner as in Example 2-4 was heated at 100° C. or 150° C., followed by subjecting to infrared spectrometry. The results are collectively shown in FIG. 21. It can be understood that the relative peak intensity of the CH stretching of oleylamine further largely decreased as compared with when the acetone treatment was performed.

The cyclic voltammetry measurement results using the above-mentioned electrode member are shown in FIG. 22. In the electrode member left at 150° C., the electrochemical responsiveness was clearly improved (solid line in FIG. 22). Also in the electrode member left at 100° C., the electrochemical responsiveness was improved (dashed line in FIG. 22). In contrast, the electrochemical responsiveness did not improve in the electrode member treated at 50° C. (dashed-dotted line in FIG. 22). From this result, it is understood that the electrochemical responsiveness of the electrode member for a reversibly color changeable display device of the present invention can be enhanced by heat treatment.

### INDUSTRIAL APPLICABILITY

As described above, the electrode member for a reversibly color changeable display device of the present invention can be obtained, while controlling the optical properties of the Prussian blue-type metal complex-ultrafine particles, and it can provide a reversibly color changeable display device which can adjust and display various colors and subtle colors. According to the reversibly color changeable display device, in the case of a non-light emitting display, colors can be displayed corresponding to cyan, yellow, and magenta, and in the case of a light emitting (transmission) display, colors can be displayed corresponding to R, G, and B.

Further, according to the electrode member for a reversibly color changeable display device of the present invention, improvements in a device manufacturing cost, a quality, and a displayed image quality can be expected, because use can be made of a film formation method, such as spin coating, which is inexpensive and suitable for ultrafine processing and which can form a film having a uniform film thickness. Furthermore, the electrode member for a reversibly color changeable display device of the present invention is also favorable for mass production, because the electrode member can be produced by a simple process. Moreover, since ultrafine particles are used as a color-developing material, the electrode member for a reversibly color changeable display device of the present invention can provide a bendable flexible image display device when a flexible material is used for structural materials, such as an insulator.

Having described our invention as related to the present embodiments, it is our intention that the invention not be limited by any of the details of the description, unless otherwise specified, but rather be construed broadly within its spirit and scope as set out in the accompanying claims.

1. An electrode member for a reversibly color changeable display device, comprising:
a transparent electrically-conductive structural layer; and
a reversibly color changeable film layer disposed at one side of the transparent electrically-conductive structural layer, the reversibly color changeable film layer being formed by a dispersion liquid containing ultrafine particles,
so that a color of the reversibly color changeable film layer can be changed under control, by applying a voltage thereto, with an electrolyte layer provided at one side of the reversibly color changeable film layer, and an electrically-conductive counter electrode structural layer provided at an outside of the electrolyte layer.

2. The electrode member for a reversibly color changeable display device according to claim 1, wherein the ultrafine particles are Prussian blue-type metal complex-ultrafine particles.

3. The electrode member for a reversibly color changeable display device according to claim 1, wherein the ultrafine particles are ultrafine particles which have an average particle diameter of 200 nm or less and in which one or two or more compound containing a pyridyl group or an amino group is coordinated as a protecting ligand to
a Prussian blue-type metal complex crystal having a metal atom M₁ and a metal atom M₂ set forth in the below:
the metal atom M₁: at least one metal atom selected from the group consisting of vanadium, chromium, molybdenum, tungsten, manganese, iron, ruthenium, cobalt, nickel, platinum, rhodium, osmium, iridium, palladium, and copper;
the metal atom M₂: at least one metal atom selected from the group consisting of vanadium, chromium, manganese, iron, ruthenium, cobalt, rhodium, nickel, palladium, platinum, copper, silver, zinc, lanthanum, europium, gadolinium, lutetium, barium, strontium, and calcium.

4. The electrode member for a reversibly color changeable display device according to claim 3, wherein the protecting ligand has carbon atoms of 4 or more and 100 or less.

5. The electrode member for a reversibly color changeable display device according to claim 3, wherein the protecting ligand is represented by any one of formulae (1) to (3): 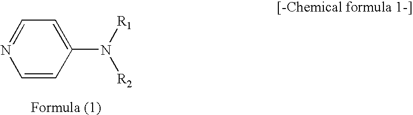
wherein R₁ and R₂ each independently represent a hydrogen atom, or an alkyl group, alkenyl group or alkynyl group having 8 or more carbon atoms; 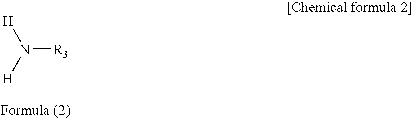
wherein R₃ represents an alkyl group, alkenyl group or alkynyl group having 8 or more carbon atoms; 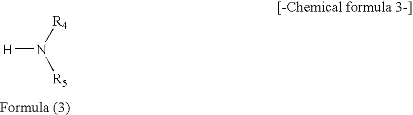
wherein R₄ represents an alkyl group, alkenyl group or alkynyl group having 6 or more carbon atoms; and R₅ represents an alkyl group, an alkenyl group, or an alkynyl group.

6. The electrode member for a reversibly color changeable display device according to claim 5, wherein the substituents R₁ to R₄ each represent an alkenyl group.

7. The electrode member for a reversibly color changeable display device according to claim 3, wherein a content of the protecting ligand compound in the reversibly color changeable film layer is 10 times or less a content of the Prussian blue-type metal complex in terms of mass ratio.

8. The electrode member for a reversibly color changeable display device according to claim 1, wherein the reversibly color changeable film layer is a liquid film layer having a uniform thickness which is formed by a dispersion liquid containing the Prussian blue-type metal complex-ultrafine particles by a film formation method selected from a spin coating method, a spraying method, an ink jet method, and a printing method.

9. The electrode member for a reversibly color changeable display device according to claim 1, wherein the dispersion liquid is a dispersion liquid of the Prussian blue-type metal complex-ultrafine particles, which is prepared by a stirring-extraction method.

10. The electrode member for a reversibly color changeable display device according to claim 3, wherein the protecting ligand is removed by heating and/or washing at the time of and/or after the reversibly color changeable film layer is formed.

11. The electrode member for a reversibly color changeable display device according to claim 1, wherein the reversibly color changeable film layer contains an agent for controlling electrochemical properties and/or an agent for controlling color-development properties.

12. The electrode member for a reversibly color changeable display device according to claim 1, wherein the reversibly color changeable film layer has a plurality of film layers, which at least comprise a layer containing the ultrafine particles and a layer containing an agent for controlling electrochemical properties and/or an agent for controlling color-development properties.

13. A reversibly color changeable display device, comprising:
an electrolyte layer provided at one side of the reversibly color changeable film layer of the electrode member for a reversibly color changeable display device according to claim 1; and
an electrically-conductive counter electrode structural layer provided at an outside thereof.

14. The reversibly color changeable display device according to claim 13, wherein:
the electrode member for a reversibly color changeable display device is an electrode member having a transparent insulating layer, in which a transparent electrically-conductive film is provided at one side of the transparent insulating layer, and the reversibly color changeable film layer is provided at another side of the transparent insulating layer;
the electrically-conductive counter electrode structural layer is a structural layer having a counter electrode insulating layer, in which an electrically-conductive counter electrode film is provided at one side of the counter electrode insulating layer; and
an electrolyte layer is placed between the reversibly color changeable film layer and the counter electrode film.

15. The reversibly color changeable display device according to claim 13, wherein the transparent electrically-conductive structural layer and the electrically-conductive counter electrode structural layer are in a form of sheet.

16. The reversibly color changeable display device according to claim 13, wherein a counter electrode modifying layer is provided between the electrolyte layer and the electrically-conductive counter electrode structural layer.

17. The reversibly color changeable display device according to claim 13, wherein a periphery of the electrolyte layer is sealed with a sealing material.

18. A reversibly color changeable display device, wherein the reversibly color changeable film layer of the electrode member according to claim 1 is formed into a pattern and/or a character pattern with a dispersion liquid in which ultrafine particles are dispersed, an electrolyte layer is provided at one side of the film layer, and an electrically-conductive counter electrode structural layer is provided at an outside thereof,
so that the pattern and/or the character is displayed under electrical control.

19. A reversibly color changeable lighting control device, comprising:
an electrolyte layer which is provided at one side of the reversibly color changeable film layer of the electrode member according to claim 1; and
a transparent electrically-conductive counter electrode structural layer which is provided at an outside thereof,
so that a transmitted light is electrically controlled for controlling light.

20. A method of producing the electrode member according to claim 1 for a reversibly color changeable display device, comprising the steps of:
preparing a dispersion liquid in which ultrafine particles of a Prussian blue-type metal complex having a protecting ligand are dispersed by a stirring-extraction method or a reversed micelle method; and
applying the dispersion liquid to one side of a transparent electrically-conductive structural layer, to form a reversibly color changeable film layer.

21. The method of producing an electrode member for a reversibly color changeable display device according to claim 20, wherein:
the protecting ligand is a compound containing an amino group or a pyridyl group; and
the dispersion liquid is applied to form the film by a film formation method selected from a spin coating method, a spraying method, an ink jet method, and a printing method.

22. The method of producing an electrode member for a reversibly color changeable display device according to claim 20, further comprising:
removing the protecting ligand by washing and/or heating at the time of and/or after the formation of the reversibly color changeable film layer.

23. The method of producing an electrode member for a reversibly color changeable display device according to claim 20, wherein:
the metal atom M₁ and/or the metal atom M₂ of the Prussian blue-type metal complex each are a combination of two or more metals; and
the metal compositions are changed, to control optical properties of the complex, thereby to obtain ultrafine particles capable of developing a desired color under electrical controlling.
